(19) United States
(12) Patent Application Publication
(10) Pub. No.: US 2024/0074403 A1
(43) Pub. Date: Mar. 7, 2024

(54) LITTER BOX CONTAINMENT SYSTEM FOR PETS

(71) Applicant: Arrival Enterprises, LLC, Bridgeton, MO (US)

(72) Inventor: Christopher J. Jeglia, Bridgeton, MO (US)

(73) Assignee: Arrival Enterprises, LLC, Bridgeton, MO (US)

(21) Appl. No.: 18/505,915

(22) Filed: Nov. 9, 2023

Related U.S. Application Data
(63) Continuation-in-part of application No. 17/100,460, filed on Nov. 20, 2020.
(60) Provisional application No. 62/939,073, filed on Nov. 22, 2019.

(51) Int. Cl. A01K 1/01

(52) U.S. Cl. CPC A01K 1/0107

(57) ABSTRACT

A Litter Box Containment System for Pets has a base with sealed walls on four sides that prevents cat urine from leaking onto an adjacent floor, a cover that detaches from the base and fits beneath the base during usage, a ramp with ribbed tread surface, and a holder for accessories. The base has a planar rectangular plate with edges on its perimeter perpendicular to the plane of the plate. The interior of the base has a waterproof liner that prevents any pet urine leakage from pet usage from staining the floor below. Within the base, it stores a ramp with tread material on its inclined surface that catches the litter from a pet's paws and an accessory holder for litter scoops. The system has an open configuration with the cover secured beneath the base and a closed configuration with the cover secured to the edges.

### CROSS-REFERENCE TO RELATED APPLICATION

This continuation in part application claims priority to the pending non-provisional application Ser. No. 17/100,460 filed Nov. 20, 2020 which claims priority to the expired provisional application Ser. No. 62/939,073 filed on Nov. 22, 2019 and all applications are owned by the same inventor.

### BACKGROUND OF THE INVENTION

The present invention relates to furniture suitable for pets in a residence. The Litter Box Containment System for Pets has particular utility in containing litter within a sealable, portable container.

Much like other animals, a cat urinates and defecates. Unlike other animals, a cat prefers a tidy place for those two tasks. When that place becomes dirty, a cat will pout or do those two tasks elsewhere. A cat outdoors has plenty of other places to choose from. A cat indoors may perform those two tasks at a less than desirable location.

Cats often prefer sandy or loose soil locations for those two tasks. Then the cat may bury or conceal the waste. Outdoor cats choose such locations readily. But a cat owner must provide a similar location for a housecat. From before the Egyptians, people have taken in cats, loved them, and made them pets. Over the centuries, owners and cats got along while owners accepted their role as staff to the cats. Owners would provide suitable housing for the cats and food from time to time.

In recent centuries, owners put cats to work ridding places of vermin. Such places included homes, barns, grain storage bins, and the like. Cats had a food source from the vermin and lived within the structures. Cats at work had an enjoyable life though perhaps a truncated one from workplace hazards, larger animals, and the like. In the last few decades, owners have eased the lives of many cats and brought them indoors to the home with limited work to do. Yet, cats still produce their waste. Owners and industry have responded with a wide variety of litter, litter boxes, and small pet houses.

Though this specification uses the word cat, the description of the invention applies to other pets and small livestock who utilize litter and to some extent woodchips. This description utilizes the words cat and pet interchangeably. Also, where a feminine pronoun is used, the masculine pronoun is implied, as cats, pets, and livestock have both genders.

### DESCRIPTION OF THE PRIOR ART

Many owners have experienced collecting litter waste from cats only to find the litter making its way from a litter box to the nearby floor. A cat may kick the litter out of the litter box with her paw. A cat may carry litter on her legs and the litter falls on its own from the fur. A cat may have litter upon her paws that detaches from the paw and falls. Some litter boxes have a location on a concrete floor that withstands litter. Other litter boxes have a location on a wood floor that may have collected litter in crevices. Other litter boxes have their locations on a vinyl floor that may temporarily receive litter pressed into it beneath a person's shoe. For some floors, litter may leave a permanent indentation.

From time to time, owners of cats may desire to relocate a litter box. For a short move, the owner pushed the litter box to another part of the floor in the same room. For a longer move, the risk of an owner spilling the litter increases. Doing a longer move calls for guiding the cat out of the box, cleaning the box, moving the box, and reassembling the box. Owners have enough else going on in their lives and seek to minimize work in moving a litter box.

Though preceding description has referred to residential settings, the description also applies to cats kept in light industrial and other facilities for rodent control. While the above-described devices fulfill their respective, particular objectives and requirements, the aforementioned devices do not describe a Litter Box Containment System for Pets that permits capture and retention of litter near a litter box, scratch resistance of the System to nearby floor, covering of a litter box for transport, and a handle for carrying the System from one location to another. Therefore, a need exists for new and improved Litter Box Containment System for Pets that can be used for capturing litter and then moving the litter box. In this regard, the present invention substantially fulfills this need. In this respect, the Litter Box Containment System for Pets according to the present invention substantially departs from the conventional concepts and designs of the prior art, and in doing so provides a device primarily developed for the purpose of capturing litter, moving a litter box, and avoiding scratching of floors in a home, an office, a light industrial setting, and the like.

The Litter Box Containment System for Pets overcomes the above-mentioned disadvantages and drawbacks of the prior art. As such, the general purpose of the present invention, which will be described subsequently in greater detail, is to provide a new and improved Litter Box Containment System for Pets which has all the advantages of the prior art mentioned heretofore and many novel features that result in Litter Box Containment System for Pets which are not anticipated, rendered obvious, suggested, or even implied by the prior art, either alone or in any combination thereof.

### SUMMARY OF THE INVENTION

The Litter Box Containment System for Pets, or the Victoria Litter Box Pet Tray®, has a base with sealed walls on four sides that prevents cat urine from leaking onto an adjacent floor, a cover that detaches from the base and fits under it during usage, a ramp with ribbed tread surface inside the base, and a holder for accessories. The Litter Box Containment System for Pets begins with a base made of a planar rectangular sheet that has edges on all four side of the base. The interior of the base has a water impervious liner, a sheet, a layer, or a cover of a waterproof material that prevents any urine leaking that may occur during pet box usage from staining the floor. Within the base, the invention stores a pet ramp that has a tread material on its upper surface that catches the pet litter from a pet's paws and that has an accessory holder for pet litter scoops.

This invention has additional storage behind the outside of the box for extra items, such as a brush and a dust pan to use for keeping the tray clean. During usage of the invention, a pet walks up to the Litter Box Containment System for Pets and steps into the base and walks up the ramp, which has an inclined surface, enters a tray, and then uses the litter in the tray within the base. The pet then exits the tray and walks down the ramp while the tread on the pet ramp removes most of the litter that has accumulated on the pet's paws. Any litter knocked out of the pet box during usage collects within the base of the invention.

The Litter Box Containment System for Pets is a self-contained unit with a removable cover attached with cooperating strips of pointed material and strips of soft adhere and a handle for easy carrying. Both types of strips join to select parts of the invention using adhesive. The cooperating strips of the invention can be Velcro® of Velcro IP Holdings LLC of Manchester, NH, or a Velcro-like material when the unit is in use. When the pet owner is ready to move to a new residence, the owner reattaches the cover aligning its soft stripes to the pointed strips upon the edges of the base and the pet owner takes the Litter Box Containment System for Pets to a new location using the handle.

There has thus been outlined, rather broadly, the more important features of the invention in order that the detailed description thereof that follows may be better understood and in order that the present contribution to the art may be better appreciated.

The Litter Box Containment System for Pets also keeps the room where unit is in use and the rest of the house free of most of the pet litter from the pet box that a pet's paws transfer out of the pet box following the pet's usage of the box. This saves the homeowner time and stress from cleaning pet litter from around the house that has escaped from the pet box during usage.

This invention also has a waterproof surface on the inside of the tray for easy cleanup of pet urine, a pet ramp that catches the pet litter that accumulates on the pet's paws, and an accessory holder for litter scoops. This invention also prevents the floor of the room of its usage from retaining stains of pet urine or pet litter indentations on wood floors. Additional features of the invention will be described hereinafter, and which will form the subject matter of the claims attached.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and devices for carrying out the several purposes of the present invention. It is important, therefore, that the claims be regarded as including such equivalent constructions insofar as they do not depart from the spirit and the scope of the present invention.

It is therefore an object of the present invention to provide a new and improved Litter Box Containment System for Pets that may be easily and efficiently manufactured and marketed to the consuming public.

Still another object of the present invention is to provide a Litter Box Containment System for Pets having a self-contained unit with a removable lid attached with screws and a handle. A pet owner may remove the screws and store them, and the lid attaches to the base of the unit with Velcro®, or other hook and loop fasteners during usage.

Still another object of the present invention is to provide a Litter Box Containment System for Pets that moves readily to a new residence as the pet owner reattaches the lid with the screws and then carries the invention to a new location using the handle.

Still another object of the present invention is to provide a Litter Box Containment System for Pets that lessens the burdens and hassles upon a pet owner.

Still another object of the present invention is to provide a Litter Box Containment System for Pets that retains litter placed within it.

Still another object of the present invention is to provide a Litter Box Containment System for Pets that provides a pet ramp with a tread top and a built in accessory holder for pet litter scoops and has a shape for storage of the pet ramp within the unit.

Still another object of the present invention is to provide a Litter Box Containment System for Pets that will fit most size pet boxes and includes additional storage behind the box for extra items, such as a brush and a dust pan for keeping the tray clean.

Still another object of the present invention is to provide a Litter Box Containment System for Pets that occupies a minimum of surface area in a home, thus saving space for a pet owner.

Still another object of the present invention is to provide a Litter Box Containment System for Pets that minimizes tipping of the invention during usage.

Still another object of the present invention is to provide a Litter Box Containment System for Pets that avoids scratching a supporting surface, such as a floor.

Still another object of the present invention is to provide a Litter Box Containment System for Pets that avoids staining a floor and prevents indentations in flooring from an owner stepping upon litter.

Still another object of the present invention is to provide a Litter Box Containment System for Pets that fits through a residential doorway.

Still another object of the present invention is to provide a Litter Box Containment System for Pets that has a lid attaching to its base with removable and reusable mechanical fasteners.

Still another object of the present invention is to provide a Litter Box Containment System for Pets that has a lid has at least one strip of hook and loop fastener upon its exterior surface and a layer of non-marring, or felt like, material upon its opposite interior surface.

Still another object of the present invention is to provide a Litter Box Containment System for Pets that has a lid that detaches from the top of the unit and reattaches to the base of the system becoming the bottom of the invention during its usage.

Still another object of the present invention is to provide a Litter Box Containment System for Pets that has a lid with its felt like material presented to a supporting floor surface to avoid scratching the floor and preventing pet urine and pet related debris from contacting the floor.

Still another object of the present invention is to provide a Litter Box Containment System for Pets that has a permanently attached handle for ready movement of the invention.

Still another object of the present invention is to provide a Litter Box Containment System for Pets that has a sturdy, lightweight construction that resists staining and liquid absorption.

Still another object of the present invention is to provide a Litter Box Containment System for Pets that provides for ready cleaning of the interior and the exterior of the invention and shows no damage to the invention from any liquid left upon it.

Still another object of the present invention is to provide a Litter Box Containment System for Pets that avoids retention of odors from liquids deposited in the invention by pets.

Still another object of the present invention is to provide a Litter Box Containment System for Pets that provides an adjustable pet ramp with a ribbed polymer surface for tread, that has its location near the front of the invention, and the ribbed surface captures litter transferred from a pet's paws.

Still another object of the present invention is to provide a Litter Box Containment System for Pets that keeps the nearby area of the invention free from cat litter transferred out of a litter box on the paws of the cat or other household pet.

Still another object of the present invention is to provide a Litter Box Containment System for Pets that holds at least one existing pet litter box within it and that readily places upon a floor accessible by household pets.

Still another object of the present invention is to provide a Litter Box Containment System for Pets that uses no tools for its assembly.

Still another object of the present invention is to provide a Litter Box Containment System for Pets that assembles and disassembles readily and easily.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

In referring to the drawings,

FIG. 1 is a perspective view of the preferred embodiment of the present invention;

FIG. 2 is a perspective view of the invention when closed;

FIG. 3 shows an exploded view of the invention;

FIG. 4 illustrates a top view of the invention when closed;

FIG. 5 shows a bottom view of the invention when open;

FIG. 6 is a side view of the invention;

FIG. 7 is a side view of the invention opposite that of FIG. 6;

FIG. 8 is a rear view of the invention;

FIG. 9 is a front view of the invention;

FIG. 10 is a top view of the base;

FIG. 11 is a sectional view of the base;

FIG. 12 is a section view of the base perpendicular to FIG. 11;

FIG. 13 is a top view of the lid;

FIG. 14 is a bottom view of the lid;

FIG. 15 is a front view of the lid;

FIG. 16 is a rear view of the lid;

FIG. 17 is a side view of the lid;

FIG. 18 is a side view of the lid opposite FIG. 17;

FIG. 19 is a perspective view of an alternate embodiment of the invention;

FIG. 20 is a perspective view of another alternate embodiment of the invention;

FIG. 21 is a perspective view of the alternate embodiment of the invention inverted from FIG. 20;

FIG. 22 is a top view of the alternate embodiment of the invention;

FIG. 23 is a bottom view of the alternate embodiment of the invention;

FIG. 24 is a front view of the alternate embodiment of the invention;

FIG. 25 is a rear view of the alternate embodiment of the invention;

FIG. 26 is a side view of the alternate embodiment of the invention;

FIG. 27 is another side view opposite that of FIG. 26;

FIG. 28 is a top view of the cover of the alternate embodiment;

FIG. 29 is a bottom view of the cover opposite that of FIG. 28;

FIG. 30 is a top view of the alternate embodiment with the cover removed;

FIG. 31 is an exploded perspective view of the alternate embodiment of the invention;

FIG. 32 is a top view of the base of the alternate embodiment;

FIG. 33 is a front view of a longitudinal edge extender of the alternate embodiment;

FIG. 34 is a rear view of a longitudinal edge extender;

FIG. 35 is a bottom view of a longitudinal edge extender;

FIG. 36 is a top view of a longitudinal edge extender;

FIG. 37 is a side view of a longitudinal edge extender;

FIG. 38 is another side view of a longitudinal edge extender opposite FIG. 37;

FIG. 39 is a front view of a lateral edge extender of the alternate embodiment;

FIG. 40 is a rear view of a lateral edge extender;

FIG. 41 is a bottom view of a lateral edge extender;

FIG. 42 is a top view of a lateral edge extender;

FIG. 43 is a side view of a lateral edge extender;

FIG. 44 is another side view of a lateral edge extender opposite FIG. 43;

FIG. 45 is a perspective view of the base of the alternate embodiment with a lateral edge extender, two longitudinal edge extenders, and a ramp installed;

FIG. 46 is top view of the alternate embodiment showing the tops of the a lateral edge extender, the longitudinal edge extenders, and the ramp;

FIG. 47 is a front view of the ramp of the alternate embodiment;

FIG. 48 is a rear view of the ramp;

FIG. 49 is a side view of the ramp;

FIG. 50 is another side view of the ramp opposite that of FIG. 49;

FIG. 51 is a bottom view of the ramp;

FIG. 52 is a front view of the holder of the alternate embodiment;

FIG. 53 is a rear view of the holder;

FIG. 54 is a top view of the holder;

FIG. 55 is a bottom view of the holder;

FIG. 56 is a side view of the holder;

FIG. 57 is another side view of the holder opposite FIG. 56;

FIG. 58 is a top view of the tray of the alternate embodiment of the invention;

FIG. 59 is a bottom view of the tray; and

FIG. 60 is a side view of the tray, and as the tray has symmetry this view also shows the front, the rear, and the other side of the tray.

The same reference numerals refer to the same parts throughout the various figures.

### DESCRIPTION OF THE PREFERRED EMBODIMENT

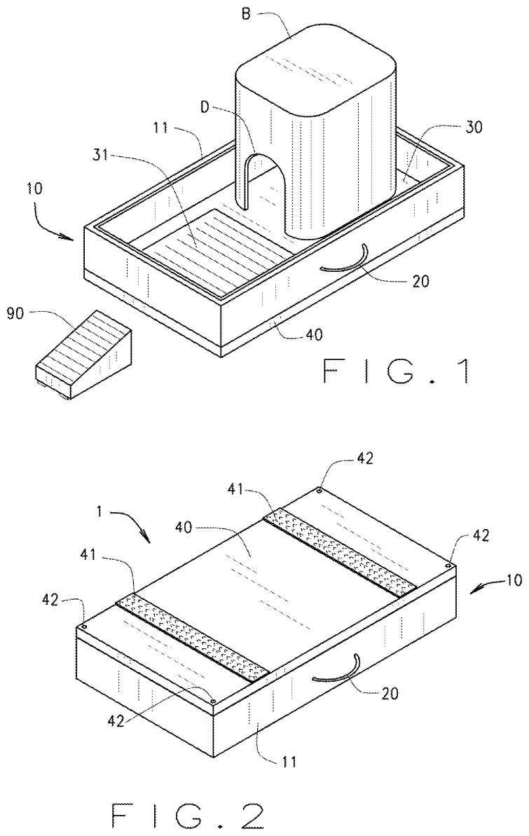

Referring now to the drawings, and particularly to FIGS. 1-60, a preferred embodiment and alternate embodiments of the Litter Box Containment System for Pets of the present invention is shown by the reference numeral 1. The Litter Box Containment System for Pets also goes by the name of Victoria Litter Box Pet Tray®. The Litter Box Containment System for Pets keeps the pet litter from inside the pet box from going out into the room and thus, into the rest of the house after the pet has used the pet box. The present invention relates to furniture suitable for pets in a residence. This system also keeps the floor of the room where it is in use from pet urine staining and from pet litter indentations.

This invention keeps the room where unit is in use and the rest of the house free of most of the pet littler from inside the pet box that gets transferred out of the pet box on the pets' paws after the pet has used the box. This saves the homeowner time and stress from cleaning up pet litter around the house that has gotten out of the pet box during usage.

In FIG. 1, the present invention 1 has a generally rectangular form shown as a perspective view of the preferred embodiment in an open configuration. The open configuration, or position, allows a cat to enter the invention. The invention 1 admits an existing litter box B, or a pet house, within it as shown that has a door D, or entry. The litter box fits within the base 10 here having a hollow rectangular form with a perimeter and upright edges, as at 11, upon the perimeter of the base, more particularly its base, as later described. One edge has a handle 20 generally centered and denoting the right of the invention as seen by a cat.

The base and the edges have a waterproof layer, as at 30, upon their interior surfaces for easy cleaning of pet urine. The base also has a tread layer 31 here shown ahead of the litter box B. The tread layer occupies less than half of the length and width of the base. The tread layer has a rug like texture that engages the fur of the cat to dislodge litter upon it. Then beneath the base 10, the invention has its lid 40 that spans beneath the entire footprint of the base. The lid does not scratch or mar any floor beneath it.

Outwardly from the base in this figure, the invention 1 also has a ramp 90 that catches some of the pet litter that accumulates on the pet's paws after use of the pet box and an accessory holder—not shown—for litter scoops. The ramp has a base with a non-marring surface and a perimeter, four edges upon the perimeter with two edges being mutually parallel and of trapezoidal shape, a handle upon one trapezoidal shaped edge, and a scratch surface, as at 31 spanning between the four edges and above the base. The ramp has a size to fit within the base 10 and a height comparable to that of a lateral edge. The pet ramp may have two handles 20 on either trapezoidal edge for easy pickup to clean the unit. A tread material 31, with ribs, covers the top of the ramp 90. Opposite the tread material, the ramp has its strip of releasable fastener.

Before the invention appears as in FIG. 1, the pet owner carries it to a location. A pet owner does so with the invention in its closed configuration shown in FIG. 2 as a perspective view. The invention has its base 10 with edges 11 and handle 20 as before. The invention has four edges that receive the lid 40 above the plate. The lid has a generally planar rectangular form, a thickness, a length, and a width where the length and the width fit across a thickness of the edges 11. The lid has Velcro®, other hook and loop like material, or releasable strip of fastener that connects it to the base opposite the edges during usage. In a further alternate embodiment, two edges of the base have hook and loop materials that retain the pet ramp and the accessory holder in position during use. Typically, the holder has its location upon a longitudinal edge. The lid fits upon the base, more particularly the upright edges 11, in the closed configuration and has mechanical fasteners securing it to the edges.

The lid has at least one strip 41 of releasable fastener, such as hook and loop material, that extends transverse, that is, perpendicular to the length of the lid. The at least one strip 41 has a position upon the top of the lid as shown, that is opposite a non-marring layer later shown and described. The at least one strip appears outwardly when the invention has its closed configuration, here shown in FIG. 2. The counterpart of the Velcro®, hook and loop like material, or other releasable fastener, of the strip 41, has its position on the bottom of the base as later shown in FIG. 4. The at least one strip 41 has a width of about ½ inch and a length of at least six inches.

The lid 40 attaches to the edges 11 of the base 10 by at least four mechanical fasteners 42, such as screws or a two-part fastener. The at least four screws provide removable and reusable mechanical fastening for when the unit is in storage, in transit, or in a retail store. Opposite the strip 41, the lid has its bottom surface, not shown, that when placed under the base 10 presents its bottom surface, that is, a full sheet of felt to prevent scratching a floor or a supporting surface. The lid removes from the edging 11 and attaches to the bottom of the base unit during usage. The lid has its bottom surface towards a floor or supporting surface thus preventing the invention from scratching a floor during usage. The base unit and corresponding lid of the Litter Box Containment System for Pets may have a size as small as 2 feet by 4 feet to contain one pet box or as large as 4 feet by 8 feet to contain 2 or 3 pet boxes.

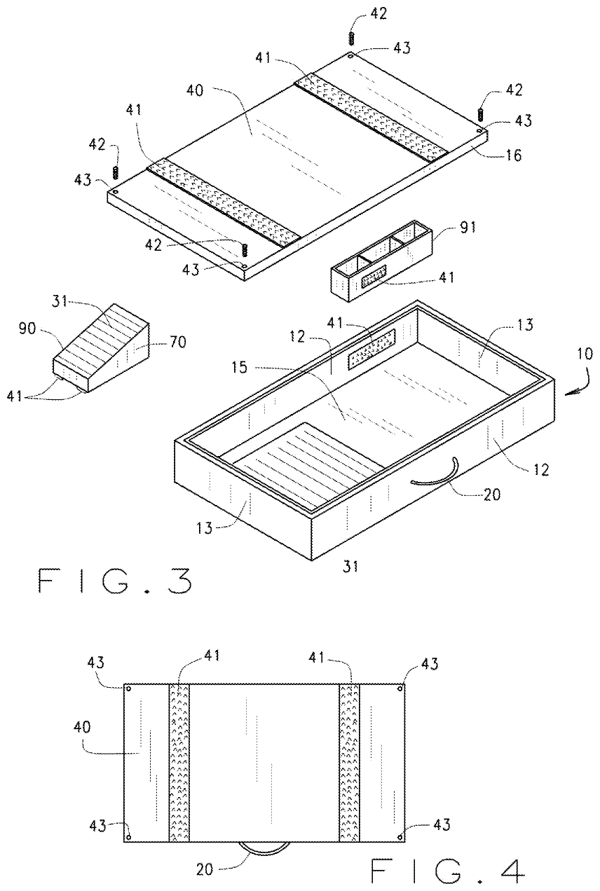

FIG. 3 shows an exploded view of the invention 1 with its base 10 towards the bottom of the figure. The base has its generally rectangular form as shown with a rectangular liner 15 upon its interior and a perimeter. Outwardly from the water impervious liner and perpendicular to the plane of the liner, the base 10 has two mutually parallel and spaced apart longitudinal edges 12 and two mutually parallel and spaced apart lateral edges 13 perpendicular to the longitudinal edges. The longitudinal edges 12 and the lateral edges 13 form a fence around the liner 15 of the base 10 as shown. The four edge 12, 13 capture litter and contain a litter box placed within them. Towards the front of the invention, that is, lower right of the figure, the base has its handle 20 centered upon a longitudinal edge. The handle may extend outwardly for grasping by a user, or alternatively include indentations, finger holes, a grip, and the like for aiding a user to lift the invention and then carry it from one location to another. Opposite the longitudinal edge with the handle 20, the other longitudinal edge has a strip 41 of hook and loop fastener towards one lateral edge to the right of the figure. This strip near the upper right corner of the base 10 as shown receives a mating portion 41 of similar fastener upon a holder 91. The holder has an elongated, hollow, prismatic rectangular form of markedly less length and less width than that of the base 10 as shown. The holder has divided compartments for receiving tools, brushes, and other items related to the care, operation, and maintenance of a litter box.

Opposite the holder in FIG. 3, the base has its ramp 20 nearby. The ramp has its truncated sloped shape as described above and a handle 20 upon one or both trapezoidal sides as shown. Upon its slope, the ramp has a tread material adhered or attached to at a minimum a portion of the ramp. Opposite the tread material 31, the ramp has at least one strip of hook and loop material, not shown. In this figure, above the base unit, its ramp, and the holder, the invention has the lid 14 of a thin, rigid, planar, rectangular, shape as shown. The lid has its thickness, a width many times greater than the thickness, and its length greater than its width. The lid has dimensions that correspond to the longitudinal edges 12 and lateral edges 13 so that the lid fits flush upon them. The lid has four corners as shown and an aperture 43 proximate to each corner, preferably the apertures have countersinks. Each aperture receives a mechanical fastener, here shown as a screw 42, the connects the lid 14 to the base 12 when in its closed configuration. Though the description has referred to one fastener at each aperture, the Applicant foresee additional numbers and positions of fasteners and apertures that connect the lid to the base. Inwardly from the apertures, the lid has at least one strip 41 of hook and loop materials extending across its width. The at least one strip 41 cooperates with a mating at least one strip beneath the base as later shown. Opposite the strip 41, the lid has a non-marring layer 16, typically felt, soft fiber, loop material, and nylon though other materials are foreseen. The non-marring layer adheres to the entire lid.

FIG. 4 then illustrates a top view of the invention 1 in the closed configuration with the lid 14 in the foreground and upon the base 10. The lid has its rectangular shape as before that fits upon the longitudinal edges 12 and the lateral edges 13 of the base. The lid has at least one strip 41 of hook and loop material and here the figure shows two mutually parallel and spaced apart strips. These strips cooperate with counterparts beneath the base, not shown. Proximate each corner, the lid has a screw 42 into each aperture 43. Towards the bottom of this figure, the invention has its handle 20 extending beneath and outwardly from the lid. A pet owner sees the view of this figure just before lifting the invention from a floor or other supporting surface.

FIG. 5 shows a bottom view of the invention when in the open configuration previously shown in FIG. 1. The open configuration has the lid placed beneath the base flush with the plate and with the non-marring layer outward or away from the base, that is, towards a floor or other supporting surface. This view has the lid in the foreground with its non-marring layer 16 visible. The non-marring layer extends upon the entire bottom surface of the lid. Proximate each corner, the lid has a screw 42 into each aperture 43. Towards the bottom of this figure, the invention has its handle 20 extending beneath and outwardly from the lid. A pet owner sees the view of this figure just before placing the invention upon a floor or other supporting surface.

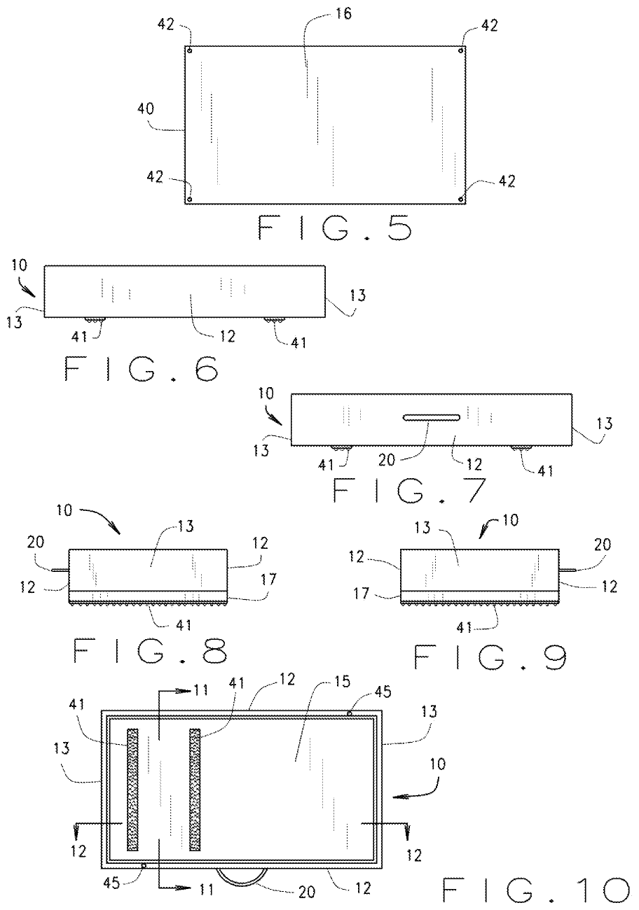

FIG. 6 is a side view of the invention, particularly the base 10. This view has a longitudinal edge 12 in the foreground. The longitudinal edge has its length that defines the length of the invention and its height perpendicular to its length that also defines the height of the invention. Its height is less than its length and of an amount suitable to retain litter within the invention but not so much that it prevents a cat or a pet from climbing over it. The longitudinal edge has two ends that join to the lateral edges 13 here shown apart. Beneath the longitudinal edge, the base has the ends of two strips 41 of releasable fastener shown that cooperate, or engage, with similar strips upon the lid as previously shown and described. The two strips attach to a plate 17 of rectangular form that defines the lowest portion of the base 10.

Turning to FIG. 7, this figure shows a side view of the invention opposite that of FIG. 6. FIG. 7 has the other longitudinal edge 12 that has the handle 20 upon it.

FIG. 8 is a rear view of the invention generally behind any litter box or cat house placed into the invention as in FIG. 1, that is opposite the ramp 90. This view shows a lateral edge 13 upon the plate 17 and perpendicular to the longitudinal edges. Below the plate, the invention has a strip 41 of hook and loop material ready to engage with the counterpart strip of releasable fastener upon the lid.

FIG. 9 is a front view of the invention opposite that of FIG. 8 and it has the handle 20 shown to the right. This view shows the other lateral edge 13 mutually parallel and spaced apart from that of FIG. 8. The handle here to the right follows the invention shown in FIG. 1, that is, as a cat or a pet would enter the invention from the ramp. Beneath the lateral edge, the base 10 has a strip 41 of releasable fastener as before.

FIG. 10 is a top view of the base 10 of the invention showing its rectangular form and interior sheet 15. This view is opposite that of FIG. 5. The interior sheet 15 provides water and urine proofing to the base and attaches to the plate 17. The plate also has the longitudinal edges 12 and the lateral edges 13 attached, or secured, upon its perimeter. The four edges cooperate to retain litter within the base 10 during usage of the invention. One longitudinal edge 12 has the handle 20 showing, here downwardly in the figure.

Further, the base includes two alignment bosses 45 that assist a user to align the lid when putting the invention into the closed configuration. The bosses fit into cooperating depressions in the lid as later shown in FIGS. 15-18. Here, the base has its alignment bosses on the longitudinal edges 12 generally opposite the plate 17 and the bosses extend perpendicular to the plane of the longitudinal edges. The two bosses have locations diagonally opposite as shown, slightly inward from corners. A user may put one boss 45 into a depression, later shown, rotate the lid 40 so it fits upon the four edges, and then secure the lid to the base using the screws 42 as previously described.

FIG. 11 is a sectional view of the base generally parallel to a lateral edge. This view shows the plate 17 generally thin and extending across the width of the base and a strip 41 shown by its length. Opposite the strip, the plate has the two longitudinal edges 12 extending perpendicular to the plate and mutually parallel and spaced apart to each other. Each longitudinal edge shows one boss 45 shown upwardly from the plane of the section. The bosses have a generally rounded form that cooperates with depressions in registration, later shown. The plate has the sheet 15 upon it opposite the strip, that is, in the interior of the base. The longitudinal edges also have portions of sheet 15 upon them, generally denoting their interior faces. As before, the sheet provides water and urine proofing to the base. The longitudinal edges join to the plate at its perimeter using adhesive and mechanical fasteners such as nails. At the tight joint of the longitudinal edges to the plate, the invention has a bead of caulk at 46 upon the interior of the joint, that is, toward the interior of the base, and beneath the sheet 15.

FIG. 12 is a section view of the base perpendicular to FIG. 11. This view of the base appears generally parallel to a longitudinal edge 12. The longitudinal edge shown has its boss 45 here extending upwardly, that is opposite the plate 17. This view shows the plate 17 generally thin and extending across the length of the base and two strips 41 shown on their ends. Opposite the two strips, the plate has the two lateral edges 13 extending perpendicular to the plate and mutually parallel and spaced apart to each other. The plate has the sheet 15 upon it opposite the strips as above upon the interior of the base. The lateral edges also have portions of sheet 15 upon them, generally denoting their interior faces. The sheet and portions of sheet cooperate to provide water and urine proofing to the base. Portions of the sheet join to the sheet in a sealed connection. The sealed connection begins where the lateral edges 13 join to the plate 17 at its perimeter using adhesive and mechanical fasteners such as nails. At the tight joint of the lateral edges to the plate, the invention again has a bead of caulk at 46 upon the interior of the joint, that is, toward the interior of the base, and beneath the sheet 15.

Turning to the lid itself, FIG. 13 shows it in a top view. The lid 40 has its rectangular shape that fits upon the edges 12, 13 of the base 10 as previously shown and described. The lid has its top surface 40a here shown in the foreground. The top surface appears visible when the invention is in its closed configuration as previously shown in FIG. 2, that is, the top surface is outwardly or away from the edges 11. Preferably the lid has a flush orientation to the upright edges 11. The upright edges 11 have a mutual perpendicular orientation to the plate. Then the upright edges include lateral edges and longitudinal edges. The top surface has at least one strip of releasable fastener as at 41 upon it, here the figure shows two strips mutually parallel and parallel to a lateral edge 12 of the base when installed. That is the strips have a shorter length than the length of the lid. Proximate each corner of the lid, it has an aperture 43 that receives a mechanical fastener 42 as previously shown and described.

FIG. 14 then has a bottom view of the lid 40 opposite that shown in FIG. 13. Opposite it top surface 40a, the lid 40 has its non-marring layer 16, typically felt, though other materials may be used in the invention. The non-marring layer adheres to the entire lid. The non-marring layer has its own thickness that accommodates the heads of the mechanical fasteners 42 so that the heads do not abut the supporting surface. In an alternate embodiment, the apertures 43 shown in this view have countersink that admits a head of the mechanical fastener, so it is flush with the lid. The lid also has two alignment depressions 44, extending into perpendicularly into the plane of the non-marring layer 16. The two depressions 44 have mutually diagonally opposite locations as shown. The depressions 44 receive the cooperating bosses 45, in registration, previously shown in FIGS. 10-12 upon the longitudinal edges. The depressions received the bosses in coordination when a user places or rotates the lid upon the longitudinal edges and the lateral edges, so the invention attains its closed configuration.

FIG. 15 describes a side view of the lid 40 that corresponds with the view of FIG. 6. The side view is as if a pet owner would see the lid. In this view, the lid 40 has the non-marring layer 16 below and the at least one strip 41, here shown as two strips, opposite the non-marring layer. The two strips shown appear with their ends visible, that is, the shortest portion of the strip. The lid has its two depressions 44 recessed into the non-marring layer. The depressions 44 have a location outwardly from the strips 41 shown. One depression is towards the foreground and the other depression is towards the background. When a user moves the Victoria Litter Box Pet Tray® to a new place, the alignment depressions 44 and corresponding bosses 45 line up vertically with each other to assist the pet owner to correctly place the lid upon the base of the invention for better alignment when installing the screws 42 as the invention attains its closed position. The alignment depressions 44 have their locations from the lid for precise alignment with the bosses 45 on the top of the longitudinal edges 12 of the Victoria Litter Box Pet Tray® for exact placement of the lid upon the base when a user moves the invention.

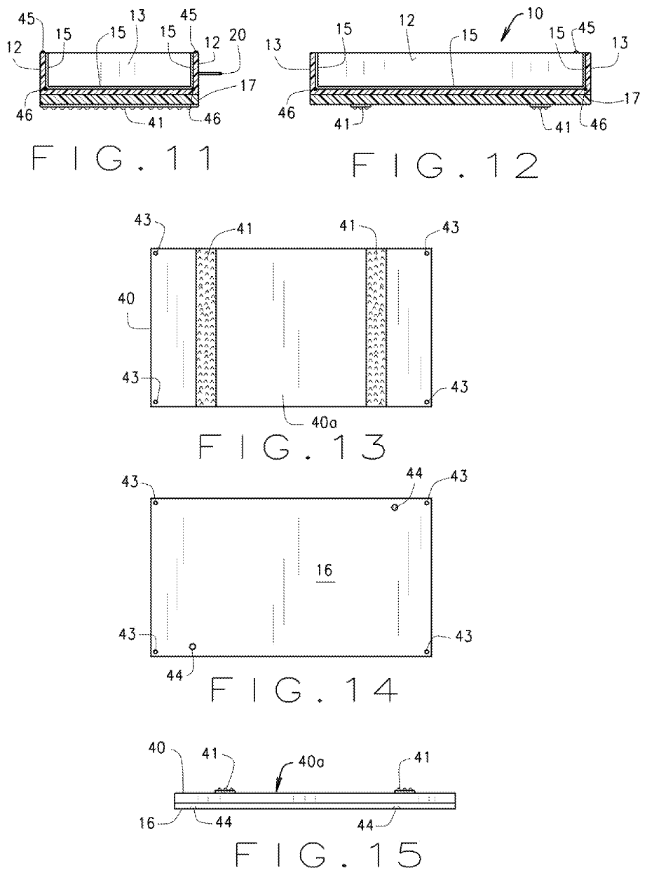

FIG. 16 describes an opposite side view of the lid 40 from FIG. 15. This view corresponds with that of FIG. 7 and a pet owner would see it when utilizing the handle. The lid also has its two alignment depressions 44 into the non-marring layer with locations outwardly from the strips 41 shown. One depression is towards the foreground and the other depression is towards the background, opposite that of FIG. 15.

FIG. 17 presents a rear view of the lid 40 generally from behind the litter box previously shown in FIG. 1. The lid 40 has the at least one strip 41 here shown lengthwise and spanning across the lid. Opposite the at least one strip 41, the lid 40 has its non-marring layer 16, also spanning across the lid. Beneath the non-marring layer, the lid also has its two alignment depressions 44 here shown to the left and the right which corresponds to the foreground and the background respectively of FIG. 15. The two depressions have diagonally opposite locations upon the lid as previously described.

FIG. 18 has a front view of the lid opposite that of FIG. 17 and generally from ahead of the litter box shown in FIG. 1 and as a cat would see the lid when deployed under the base 10 just ahead of the ramp. The lid 40 has the at least one strip 41 here shown lengthwise and spanning across the lid. The non-marring layer 16 has its position opposite the strip 40 and it also spans across the lid. The lid also has its two alignment depressions 44 in opposite locations from FIG. 17 that though correspond to the foreground and the background respectively of FIG. 15. The two depressions still have diagonally opposite locations upon the lid as previously described.

Then, FIG. 19 is a perspective view of an alternate embodiment of the invention. The invention has its base 10 as before with the lid 40 located beneath it and the non-marring layer 16 at the lowest portion of the invention, towards the bottom of the figure. The base has its longitudinal edges 12 and lateral edges 13 as described above. The edges 12, 13 has a generally elongated rectangular from with a portion of liner 15 upon their interior faces, not shown. Each edge has an upright orientation and occupies minimal area upon the plate 17. The alternate embodiment has a longitudinal edge extender 50 and two corresponding lateral edge extenders 51. These three extenders 50, 51, have combined lengths to fit upon the longitudinal edge 12 and the lateral edge 13 respectively. The two extenders also have the same thickness as the edges 12, 13 and have a portion of liner 15 denoting their interior faces that aligns with the similar portions of liner 15 upon the interior of the edges. These extenders 50, 51 are also components of the Victoria Pet Tray Edge Extender®.

To support the portions of liner upon the extenders 50, 51, the extenders have a frame like construction. Each extender has two mutually parallel and spaced apart uprights and two mutually parallel and spaced apart spanners perpendicular to the uprights. The two uprights and two spanners form a hollow rectangular frame where the spanners abut the edges 12, 13. Inwardly from the uprights and spanners, the extenders have a rigid panel that extends over the uprights and spanners thus covering the entire frame. Upon the rigid panel and opposite the frame, each extender has its portion of liner 15. The liner portion of each extender has a flush position with the portion of liner of the edge beneath. The flush position of the extender on its corresponding edge prevents litter and other materials from catching and accumulating on a ledge. One spanner has at least two apertures extending through it on axes parallel to the plane of the extender's portion of liner. The at least two apertures receive mechanical fasteners that secure the edge extender to its corresponding edge. The hollow frame of the extender permits a pet owner to use a screwdriver or other tool to connect and to remove an edge extender from its edge. The extenders have a releasable mechanical connection to their corresponding edges. The extenders have a coplanar orientation to their corresponding edges also. At a corner, one longitudinal edge extender has a mechanical connection to the adjacent lateral edge extender.

Generally, the alternate embodiment has an edge extender on at least one edge that extends the height of the base by at least one inch and matches the width of the edge as described above. Additional pieces of edge extender also connect to an adjacent edge extender using a mechanical fastener, or alternatively a tongue and groove connection. The edge extenders have the same construction as the other edges of the invention. The edge extenders prevent pet urine, pet litter, or pet litter dust from falling behind it and thus more of that area behind the edge extender and its edge below stays clean compared to an edge alone.

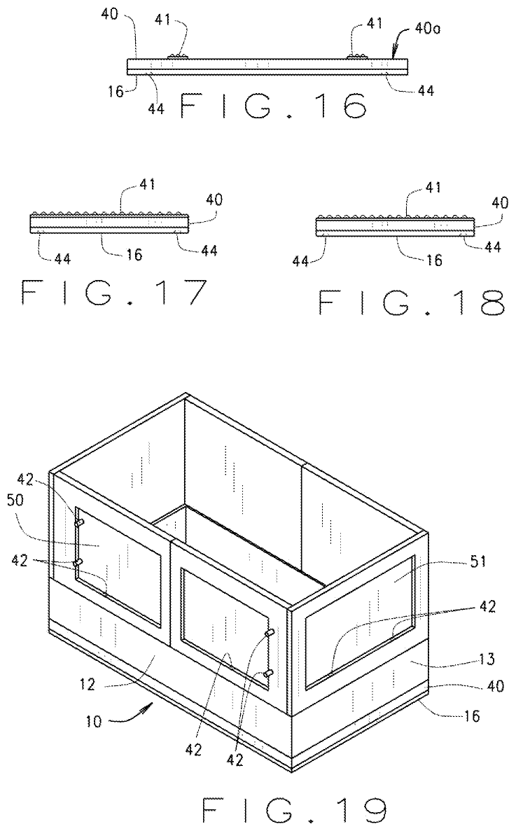

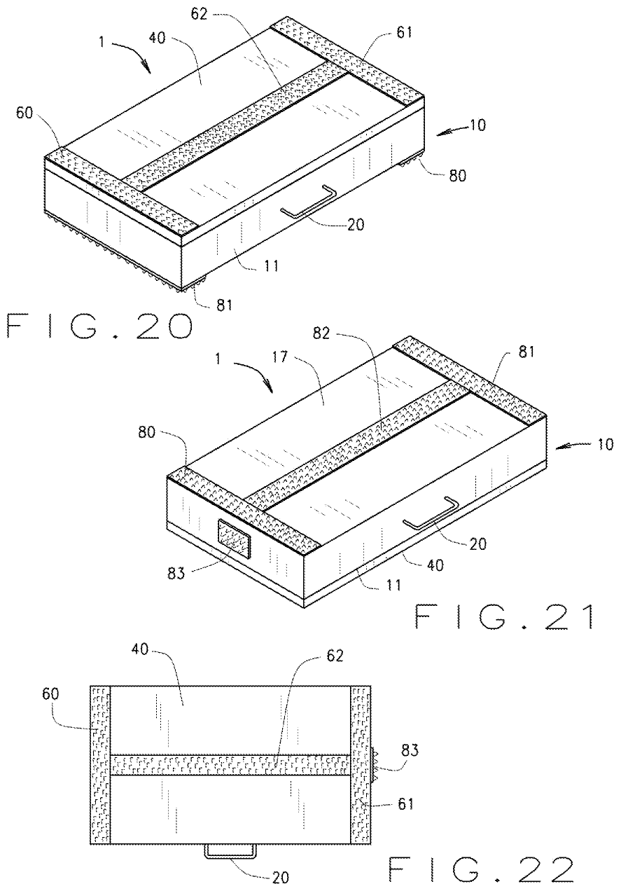

Turning to another alternate embodiment of the invention, FIG. 20 provides a perspective view of the alternate embodiment in its closed configuration, ready for movement as when a pet owner carries it to a location. A pet owner does so with the invention in its closed configuration here shown in FIG. 20. As before, the alternate embodiment has a hollow base 10 of a rectangular shape with two mutually parallel and spaced apart lateral edges 12 and two mutually parallel and spaced apart longitudinal edges 13 where the lateral edges have a perpendicular orientation to the longitudinal edges. The lateral edges and the longitudinal edges mutually extend perpendicular from a plate, not shown in this view, that is from a plane defined by the plate. Upon one longitudinal edge, the embodiment has a handle 20, generally centered. Upon the four edges, that is, the lateral edges and the longitudinal edges, a cover 40 secures to the base. The cover has a generally flat rectangular shape and a thickness far less than its width. The cover fits flush to the lateral edges and the longitudinal edges and leaves no gaps beneath it as later shown and described. The cover has Velcro®, other hook and loop like material, releasable fastener, or releasable strip of fastener that connects it to the base opposite the edges during usage.

More particularly, upon the cover shown in this view, the cover has a first pointed strip 60 and a spaced apart mutually parallel second pointed strip 61, where the word strip includes a length that far exceeds its width that exceeds its thickness. In this view the first pointed strip and the second pointed strip each have a parallel orientation to the lateral edges 13, that is, the short or depth dimension of the invention. The first pointed strip and the second pointed strip adhere to the cover and have their own widths at least ten times that of their thicknesses. The first pointed strip and the second pointed strip adhere above each of the lateral edges when the invention is in its closed configuration. Spanning between the first pointed strip and the second pointed strip, the cover has a third pointed strip 62 generally centered upon the cover. The third pointed strip has a parallel orientation to the longitudinal edges 12, that is, the invention length, or width dimension.

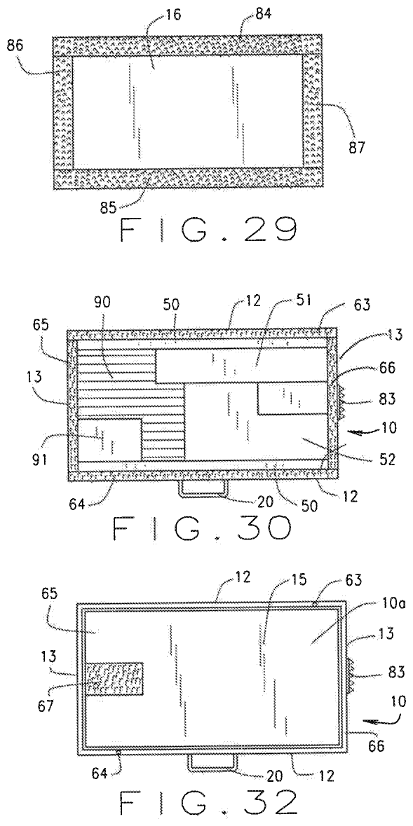

The first pointed strip, the second pointed strip, and the third pointed strip use the adjective pointed as they feel as having points when touched and the hook portion of hook and loop fastener appears akin to pointed in this description. As later shown and described, the pointed strips cooperatively engage with soft strips to secure one component of the invention to another. As shown in this figure, the first pointed strip, the second pointed strip, and the third pointed strip have an arrangement similar to the letter I, upon the cover. The first pointed strip, the second pointed strip, and the third pointed strip have their positions upon the top of the cover as shown, that is opposite the non-marring layer 16 as later shown in FIG. 29. The first pointed strip, the second pointed strip, and the third pointed strip appear outwardly when the invention has its closed configuration, here shown in FIG. 20. The counterparts of the Velcro®, hook and loop like material, or other releasable fastener, of the first strip 60, the second strip 61, and the third strip 62 have their positions on the bottom of the base as later shown in FIG. 21. The three pointed strips 60, 61, 62 have a width of at least ½ inch and a length of at least six inches.

Opposite the cover, the base 10 has beneath its rectangular plate 17 a first soft strip 80 and a spaced apart mutually parallel second soft strip 81. The rectangular plate denotes the bottom of the base. In this view the first soft strip and the second soft strip each have a parallel orientation to the lateral edges, that is, the short or depth dimension of the invention. The first soft strip and the second soft strip adhere to the plate and have their own widths at least ten times that of their thicknesses. The first soft strip and the second soft use the adjective soft as they feel akin to a cushion when touched and the loop portion of hook and loop fastener appears akin to soft in this description. As later shown and described, the soft strips of the invention cooperatively engage with pointed strips to secure one component of the invention to another. In this view, the first soft strip 80 appears on end to the right and the second soft strip 81 appears showing its length and an end to the left.

Opposite the pointed strips 60, 61, 62, the cover has its bottom surface, not shown, that when placed under the base 10 presents its bottom surface, that is, a partial sheet of felt and additional soft strips to prevent scratching a floor or a supporting surface. The lid cover from the edges 11 and attaches to the bottom of the base unit during usage. The cover has its bottom surface towards a floor or supporting surface thus preventing the invention from scratching a floor during usage. The base unit and corresponding lid of the Litter Box Containment System for Pets may have a size as small as 10 inches by 14 inches to contain one pet box or as large as 4 feet by 8 feet to contain 2 or 3 pet boxes. The alternate embodiment may take the form of a salesman's sampler of approximately 11 inches by 16 inches by 4 inches, nominally.

Grasping the handle 20 and turning this alternate embodiment of the invention clockwise, FIG. 21 shows the embodiment in a perspective view and inverted from that of FIG. 20. In FIG. 21, the plate 17 appears upwardly and the cover 40 appears beneath the base unit 10. The lateral edges 12 and the longitudinal edges 13 connect to the plate with adhesive, joinery, or mechanical fasteners. The plate has the first soft strip 80 and a spaced apart mutually parallel the second soft strip 81. As before, the word strip includes a length that far exceeds its width that exceeds its thickness. In this view the first soft strip and the second soft strip each have a parallel orientation to the lateral edges 13 on the short or depth dimension of the invention. The first soft strip and the second soft strip adhere to the base and have their own widths at least ten times that of their thicknesses. Spanning between the first soft strip and the second soft strip, the cover has a third soft strip 82 generally centered upon the base with a parallel orientation to the longitudinal edges 12, that is, the invention length, or width dimension.

As shown in this figure, the first soft strip, the second soft strip, and the third soft strip have an arrangement similar to the letter I, and that matches the arrangement of pointed strips the cover 40. The first soft strip, the second soft strip, and the third soft strip have their positions upon the bottom of the base 10 as shown, that is opposite the non-marring layer 16 concealed beneath the cover. The first soft strip, the second soft strip, and the third soft strip appear beneath and outwardly when the invention has its closed configuration, here shown in FIG. 21. The counterparts of the Velcro®, hook and loop like material, or other releasable fastener, of the first soft strip 80, the second soft strip 81, and the third soft strip 82 have their positions on the bottom of the top of the cover that was shown in FIG. 20. The three soft strips 80, 81, 82 have a width of at least ½ inch and a length of at least six inches.

The first soft strip, the second soft strip, and the third soft strip use the adjective soft as they feel so when touched and the loop portion of hook and loop fastener appears akin to pointed in this description. As later shown and described, the soft strips cooperatively engage with the pointed strips to secure the cover to the base of the invention to another. As shown in this figure, the first soft strip, the second soft strip, and the third soft strip have an arrangement similar to the letter I, upon the cover.

In this view, FIG. 21 shows one lateral edge—upon the base—towards the foreground and the left that has a fourth soft strip 83 upon it. The fourth soft strip has a generally centered location upon that lateral edge as shown and an orientation parallel to and above the first soft strip 80 as shown, that is, the lengths of the thirst soft strip and the fourth soft strip go in the same direction.

FIG. 22 the provides a top view of the alternate embodiment, that is, with the cover 40 shown towards the reader. The cover has its rectangular shape with the first pointed strip 60 to the left and the second pointed strip 61 to the right. Between those two strips, the cover has the third pointed strip 62 so that the three strips attain the arrangement of a letter I rotated ninety degrees as shown upon the cover. To the right of the cover, the fourth soft strip 83 appears on its edge awaiting an invention component as later shown.

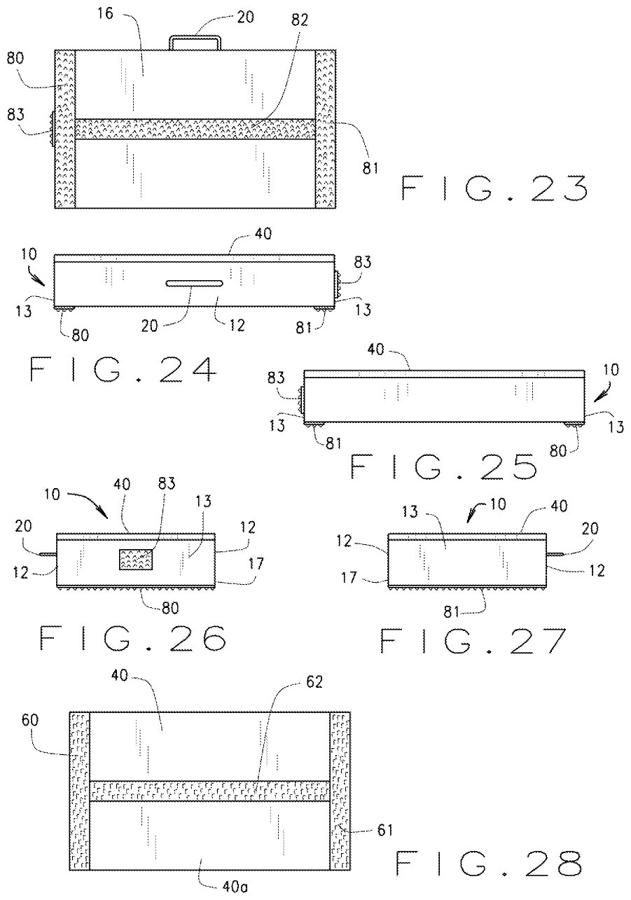

Turning the invention from that orientation in FIG. 22, FIG. 23 shows a bottom view of the alternate embodiment of the invention, still in the closed configuration as of FIG. 20. Here, the base 10, more particularly the bottom plate 17, appears towards the reader. The base has its rectangular shape as before with the first soft strip 80 and the fourth soft strip 83 to the left and the second soft strip 81 to the right. Between those two strips, the base has the third soft strip 82 so that these three strips attain the arrangement of a letter I rotated ninety degrees as shown upon the base. These three strips cooperatively engage the three pointed strips of the cover from FIG. 22 once the invention attains its open configuration shown in FIG. 30. Or put another way, the cover has its non-marring layer oriented away from the plate in the open configuration, the first pointed strip, the second pointed strip, and the third pointed strip, each upon the cover, cooperatively engaging in registration the first soft strip, the second soft strip, and the third soft strip, each of the plate.

FIG. 24 then has the alternate embodiment in a front view with the handle 20 towards the reader. The handle extends out of the plane of the figure from its centered position upon the longitudinal edge 12 shown. Above the handle, the cover 40 attaches upon the longitudinal edge 12. Below the handle and opposite the cover 40, the base has the ends of the first soft strip 80 to the left and of the second soft strip 81 to the right and the long side of the third soft strip 82 showing. To the right of the handle, the fourth soft strip 83 has its position upon one lateral edge 13.

Opposite FIG. 24, FIG. 25 provides a rear view of the alternate embodiment with the other longitudinal edge 12 towards the reader and the handle concealed into the plane of the figure. Here, towards the top of the figure, the cover 40 attaches upon the longitudinal edge 12 shown. Opposite the cover 40 and below the longitudinal edge 12, the base has the ends of the second soft strip 81 to the left and of the first soft strip 80 to the right and the long side of the third soft strip 82 showing. To the left of this figure, the fourth soft strip 83 has its position upon one lateral edge 13.

Rotating FIG. 25 to the right ninety degrees, FIG. 26 shows the alternate embodiment of the invention in a side view. This side has a lateral edge 13 towards the reader with the fourth soft strip 83 centered upon it and slightly out of the plane of this figure. Beneath the soft strip 83 and below the lateral edge, the long side of the first soft strip 80 appears as it extends between the two longitudinal edges. Opposite the first soft strip, the cover 40 attaches to the lateral edge. In this figure, the handle 20 appears to the left and extending from a longitudinal edge 12 as shown.

Opposite from FIG. 26, FIG. 27 presents another side view of the alternate embodiment. Here the handle 20 extends to the right from a longitudinal edge 12 that joins to a lateral edge 13 in the foreground. Beneath the lateral edge 13, the long side of the second soft strip 81 appears as it extends between the two longitudinal edges. Opposite the second soft strip, the cover 40 attaches to the lateral edge. FIGS. 24, 25, 26, 27 cooperatively show the cover attaching to the lateral edges 13 and the longitudinal edges 12 for the invention in the closed configuration of FIG. 20.

Let us view the cover itself, here shown in FIG. 28 as a top view for the alternate embodiment. The cover 40 has it rectangular shape with the first pointed strip 60 upon the left and the second pointed strip 61 on the right. The first pointed strip and the second pointed strip have their spaced apart and mutually parallel orientation, that is, they follow the shorter edges of the cover, as shown. Spanning between the first pointed strip and the second pointed strip, the cover has its third pointed strip 62 forming an I like shape rotated ninety degrees, or as some say, an H like shape. The first pointed strip, the second pointed strip, and the pointed strip extend outwardly from the cover, that is, out of the plane in this figure.

Turning the cover over, FIG. 29 describes a bottom view of the cover opposite that shown in FIG. 28. The cover has its rectangular shape as before but on this surface, the cover has a fifth soft strip 84 mutually parallel and spaced apart from a sixth soft strip 85. The fifth soft strip and the sixth soft strip extend along the length of the cover. Perpendicular to the fifth soft strip, the cover has a seventh soft strip 86 and a mutually parallel and spaced apart eighth soft strip 87. The seventh soft strip and the eighth soft strip extend perpendicular to the length of the cover and partially along the short edges of the cover. Preferably the seventh soft strip and the eighth soft strip have less length themselves than the fifth soft strip and the sixth soft strip. Looking at the figure in clockwise direction, the fifth soft strip, the eighth soft strip, the sixth soft strip, and the seventh soft strip form a frame around the nonmarring layer 16. In this alternate embodiment, the nonmarring layer is felt. The fifth soft strip has registration with the fourth pointed strip or the fifth pointed strip. The sixth soft strip thus has registration with the fifth pointed strip or the fourth pointed strip remaining after the fifth soft strip engages. Meanwhile, the seventh soft strip has registration with the sixth pointed strip or the seventh pointed strip. The eighth soft strip thus has registration with the sixth pointed strip or the seventh pointed strip remaining after the eighth soft strip engages. Also viewing the strips upon the cover, the fifth soft strip and the sixth soft strip have a mutually parallel and spaced apart orientation, then the seventh soft strip and the eighth soft strip have their mutually parallel and spaced apart orientation that is perpendicular to the fifth soft strip and the sixth soft strip.

As FIG. 29 described the cover detached from the base, FIG. 30 shows a top view of the alternate embodiment with the cover 40 shown removed and the other components of the invention all packed up. Without the cover, this view shows the invention open but not quite ready for feline or other pet activity. FIG. 30 shows the other components of the invention packed for storage. These components of the invention fit within the base 10 and beneath the cover 40 and inside the edges as group as at 11. More particularly, the top most longitudinal edge has a fourth pointed strip 63 shown and the bottom most longitudinal edge has a fifth pointed strip 64 upon it. Each longitudinal edge has its related pointed strip upon its full length. Mutually parallel and spaced apart, the left lateral edge has a sixth pointed strip 65 upon it and the right lateral edge has a seventh pointed strip 66 upon it, generally above the fourth soft strip 83 shown into the plane of the figure. The pointed strips shown, as at 64, 64, 65, 66 cooperatively grasp the soft strips of the cover, as at 84, 85, 86, 87, to firmly hold the cover in the closed configuration as previously shown. The lateral edge extender has a coplanar orientation with one lateral edge near the fourth soft strip, and the lateral edge extender has a perpendicular orientation to the longitudinal edge extenders.

Inward from the pointed strips, as at 64, 64, 65, 66, the base of the invention as at 10 forms a compartment 10a bounded by the two longitudinal edges 12, the two lateral edges 13, and the plate 17. In this figure, the compartment remains concealed by two longitudinal edge extenders 50 here shown on edge and spaced apart near their counterpart longitudinal edges 12, one lateral edge extender 51 here shown flat and upon a tray 52, the tray upon the plate 17 and towards the right of the compartment, a ramp 90 to the left of the tray, and a holder 91 upon the ramp towards the lower left of the compartment as shown. Opposite the lateral edge extender 51, the invention has the handle 20 upon the lower longitudinal edge as shown in the figure.

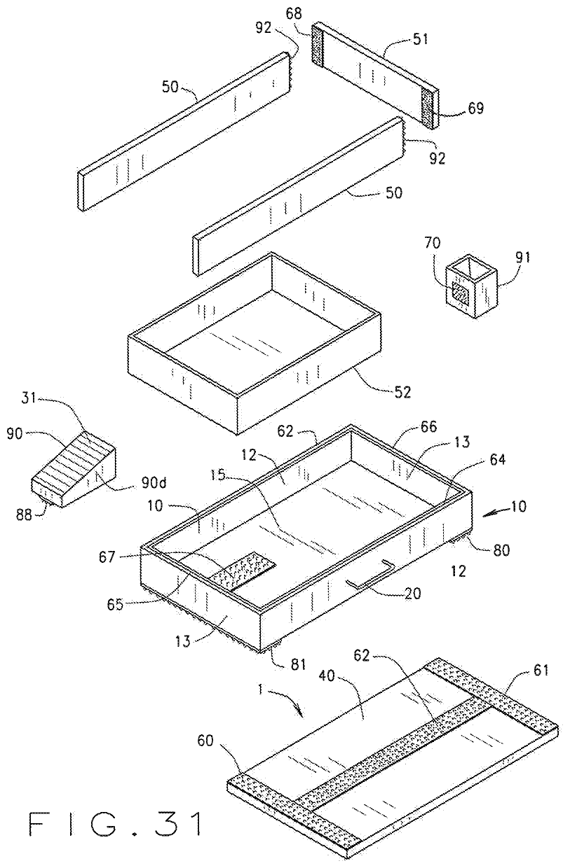

Towards the left, the base has the ramp 90 within it and upon the plate 17. The ramp has an internal position inside the base with the lower portion of the ramp towards a lateral edge 13, here shown towards the left, and the higher portion of the ramp towards the interior of the base, that is adjacent to a tray 52. During usage, a cat, or other trained pet, climbs over the lateral edge 13 and then lands on the ramp. The cat then climbs the ramp upwardly and enters the tray 52. The ramp has its tread layer 31 as previously described, here shown towards the reader. As later shown in FIGS. 31, 32, a user may remove the ramp 90 from within the base 10 by separating it from its connection to the plate and lifting it upwardly.

Having described the base and the cover in a closed configuration, see FIGS. 20-29, and the other components of the invention shown in the base, see FIG. 30, FIG. 31 is an exploded perspective view of the alternate embodiment of the invention showing the components of the invention. The invention has its cover 40 with the first pointed strip 60, the second pointed strip 61, and the third pointed strip 62 oriented upward. The position shown conceals the nonmarring layer 15, and the soft strips 84, 85, 86, 87 below.

Upward in the figure from the cover 40, the invention has its base 10 with the compartment 10a between the longitudinal edges 12, the lateral edges 13, and the plate 17. The liner 15 rests upon the plate as the bottom of the compartment. Each of the longitudinal edges 12 and the lateral edges 13 has their corresponding pointed strip, 63, 64 and 65, 66 respectively, oriented upward in the figure. The base has the eighth pointed strip 67 inward from the lateral edge to the left of the figure. Beneath the plate and below the eighth pointed strip, the base has the second soft strip 81 showing its long side beneath the lateral edge on the left and spaced apart to the right the first soft strip 80 here showing an end.

Above the plate, and particularly above the eighth pointed strip, the invention has its ramp 90 with an inclined plane shape. Upon the incline, the ramp has its tread layer 31 and opposite the tread layer, the ramp has a ninth soft strip 88 that cooperates with the eighth pointed strip 67 upon installing the ramp inside the compartment. To the right of the ramp, the figure shows the tray 52 that has a rectangular shape, alternative square shape, with four upright walls. The tray receives a portion of litter, not shown, during usage of the invention. In the salesman's sample size of this embodiment, the cover closes the tray so that litter does not escape as the invention keeps the closed configuration. And to the right of the tray, the invention has its holder 91 of a hollow, elongated, prismatic form or shape that receives tools suitable for a litter box. The holder has an eleventh pointed strip 70 upon one face, as later described, that cooperatively engages the fourth soft strip 83.

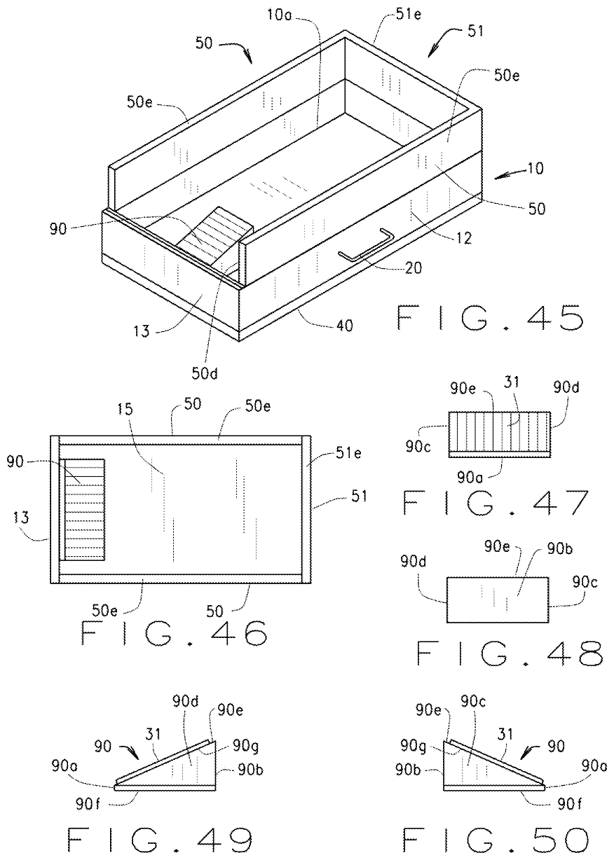

Then above the tray in this figure, the invention has its two longitudinal edge extenders 50 here shown mutually parallel and spaced apart, and with an upright orientation, that is, perpendicular to the plate 17, or parallel to their corresponding longitudinal edges 12 shown below. These two longitudinal edge extenders 50 cooperatively engage the pointed strips 63, 64, 65, 66 as later shown in FIG. 45. This figure shows the near ends of the two longitudinal edge extenders 50. Opposite the near ends, the two longitudinal edge extenders each have an eleventh soft strip 92, not shown. From the eleventh soft strips 92, the two longitudinal edge extenders 50 cooperatively engage a ninth pointed strip 68 and a tenth pointed strip 69 upon a face of a lateral edge extender 51. Akin to the longitudinal edge extenders 50, the lateral edge extender has its upright orientation perpendicular to the plate 17, and parallel to a corresponding lateral edge 13 having the fourth soft strip 83 below. This lateral edge extender 51 cooperatively engages mostly the seventh pointed strip 66 and portions of the fourth pointed strip 63 and the fifth pointed strip 64 as later shown in FIG. 45.

FIG. 32 picks up from where FIGS. 30, 31 left off. FIG. 32 shows the base 10 in a top view of the alternate embodiment but with the components removed. The base has the lateral edges 13 and the longitudinal edges 13 around the plate 17 as before and the liner 15 upon the plate into the plane of the figure but visible to the reader. The lateral edges and the longitudinal edges have their pointed strips extending out of the plane of the figure and arranged clockwise as the fourth pointed strip 63, the seventh pointed strip 66, the fifth pointed strip 64, and the sixth pointed strip 65 as shown. The fourth soft strip 83 is into the plane of the figure beneath the seventh pointed strip 66 as shown towards the right.

Opposite the lateral edge with the fourth soft strip 83, the base has the other lateral edge 13 to the left. Centered upon that lateral edge, the plate has an eighth pointed strip 67 extending into the compartment and partially along the length of the base. The eighth pointed strip receives a corresponding soft strip of the ramp 90 as later shown. The eighth pointed strip has its position centered between and parallel to a longitudinal edges.

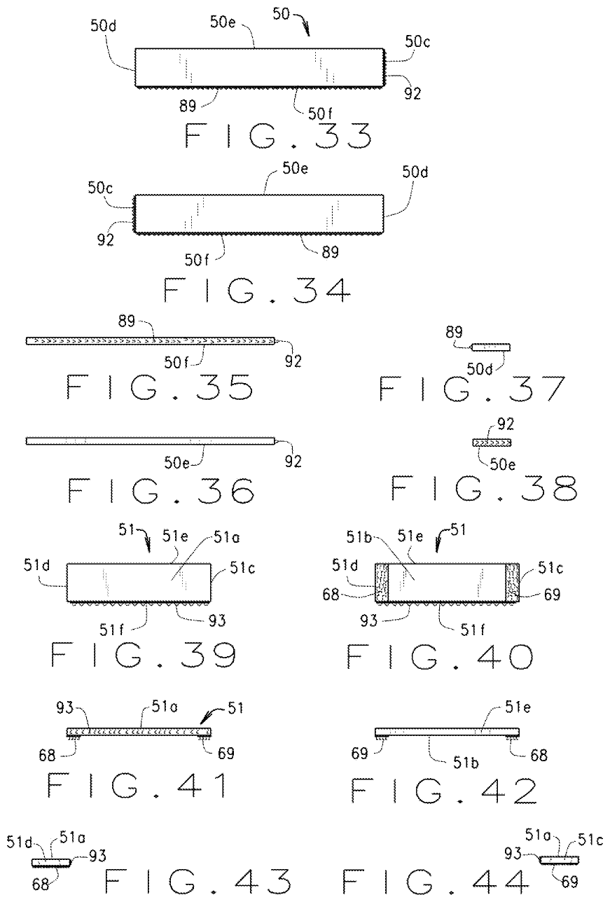

Turning to the next component of this alternate embodiment, FIG. 33 has a front view of a longitudinal edge extender 50 of a generally elongated rectangular shape. This extender has an outer face 50a here shown to the reader and to the right of the outer face 50a it has an inner end 50c. The inner end has upon it an eleventh soft strip 92 adhered to it that cooperatively engages the lateral edge extender as shown in FIG. 45. Opposite the inner end, the longitudinal edge extender has its outer end 50d that has no strip thereon. Towards the top of the figure, the longitudinal edge extender has its upper edge 50e that has no strip upon it. Opposite the upper edge, the longitudinal edge extender has its lower edge 50f that has adhered to it a tenth soft strip 89. The inner end 50c and the outer end 50d have a mutually parallel and spaced apart orientation. Perpendicular to the inner end, the upper edge 50e and the lower edge 50f also have a mutually parallel and spaced apart orientation.

FIG. 34 next has a rear view of a longitudinal edge extender, that is opposite FIG. 33. Opposite the outer face 50a, the longitudinal edge extender has its inner face 50b. The inner face 50b has a portion of liner 15 upon it as protection from pet waste that may contact the longitudinal edge extender. Similar to before, the inner face 50b also has the inner end 50c and its opposite outer end 50d, the upper edge 50e and its opposite lower edge 50f, and the corresponding soft strips as at 89, 92 to the lower edge and the inner end, respectively.

FIG. 35 then shows a bottom view of a longitudinal edge extender, more particularly the lower edge 50f with its tenth soft strip 89 adhered to it. This soft strip extends for the length of the longitudinal edge extender as shown. To the right of the figure, the longitudinal edge extender has its inner end 50c showing the eleventh soft strip 92 on its own end. That provides the inner face 50b downward and the outer face 50a upward.

FIG. 36 opposite FIG. 35 then has a top view of a longitudinal edge extender, more particularly here the upper edge 50e that has no strip. To the right of the figure, the longitudinal edge extender has its inner end 50c showing the eleventh soft strip 92 on its own end. That provides the outer face 50a downward and the inner face 50b upward.

FIG. 37 then has a side view of a longitudinal edge extender with the outer end 50d towards the reader. That provides the outer face 50a downward and the inner face 50b upward and the tenth soft strip 89 upon the lower edge 50f to the left.

FIG. 38 is another side view of a longitudinal edge extender opposite FIG. 37, so it has the inner end 50c towards the reader with its eleventh soft strip 92 visible. That provides the outer face 50a downward, the inner face 50b upward and the tenth soft strip 89 upon the lower edge 50f to the right.

Now let us move to the lateral edge extender 51 here in FIG. 39 as a front view of the alternate embodiment. The lateral edge extender has a generally elongated rectangular shape with a shorter length that a longitudinal edge extender. This lateral edge extender has its outer face 51a here shown to the reader and to the right of the outer face 51a it has a right end 51c without a strip upon it. Opposite the right end, the lateral edge extender has its left end 51d that has no strip thereon as well. Towards the top of the figure, the lateral edge extender has its upper edge 51e that has no strip upon it. Opposite the upper edge, the lateral edge extender has its lower edge 51f that has adhered to it a twelfth soft strip 93. The upper edge has a mutually parallel and spaced apart orientation to the lower edge.

FIG. 40 then has a rear view of a lateral edge extender opposite that of FIG. 39. Opposite the outer face 51a, the lateral edge extender has its inner face 51b. The inner face 51b has a portion of liner 15 upon it as protection from pet waste that may contact the longitudinal edge extender. Similar to before, the inner face 51b also has the right end 51c and its opposite left end 51d, the upper edge 51e and its opposite lower edge 51f, and the corresponding soft strip as at 93 just to the lower edge as shown here and in FIG. 39. Unlike the longitudinal edge, the lateral edge has upon its inner face 51b the ninth pointed strip 68 proximate the right end 51d and the tenth pointed strip 69 proximate the left end 51c with the twelfth soft strip 93 upon the lower edge 51f as before. The left end and the right end span between the inner face and the outer face. The ninth pointed strip and the tenth pointed strip have a mutually parallel and spaced apart orientation. This figure provides a reminder of the plate, the lateral edges, and the longitudinal edges mutually orienting inwardly of the invention their water impervious liners, all of the liners face in.

FIG. 41 next has a bottom view of the lateral edge extender 51 that has the twelfth soft strip 93 towards the reader, the outer face 51a upward, and the inner face 51b downward. The inner face has the ninth pointed strip 68, shown on end, to the left of the figure, or towards the left end 51d and the tenth pointed strip 69 proximate the right end 51d.

Rotating the lateral edge extender one hundred eighty degrees from FIG. 41, FIG. 42 has a top view of a lateral edge extender 51. In this view, the outer face 51a is upward and the upper edge 51e is towards the reader. The inner face 51b is downward which puts the tenth pointed strip 69 here shown on end to the left of the figure and the ninth pointed strip 68 here shown on end to the right of the figure.

Turning the lateral edge extender ninety degrees from FIG. 42, FIG. 43 then shows a side view of a lateral edge extender with the left end 51d towards the reader and the outer face 51a upward. Opposite the outer face, the figure shows the inner face but with the side of the ninth pointed strip 68 shown and the end of the twelfth soft strip 93 displayed towards the right.

Then FIG. 44 is another side view of a lateral edge extender opposite FIG. 43. This view has the lateral edge extender with the right end 51c towards the reader and the outer face 51a upward. Opposite the outer face, the figure shows the inner face but with the side of the tenth pointed strip 69 shown and the end of the twelfth soft strip 93 displayed towards the left.

Having shown and described the edge extenders, FIG. 45 provides a perspective view of the base of the alternate embodiment with a lateral edge extender 51, two longitudinal edge extenders 50, and the ramp 90 installed upon the base. In particular, a user, such as a pet owner, put one longitudinal edge extender 50 with its right end 50c towards the left end 51d of the lateral edge 51 and its inner face 50a towards the interior of the base. A user then places the other longitudinal edge extender 50, here shown towards the lower right, with its right end 50c towards the right end 51c of the lateral edge 51 and its inner face 50a towards the interior of the base and its outer face 50b towards the reader. The two longitudinal edge extenders 50 have a mutually parallel and spaced apart orientation with the lateral edge extender 51 toward the upper right in the figure and to the right of both extenders as shown. The lateral edge extender 51 and two longitudinal edge extenders 50 have their inner faces 50b, 51b oriented towards the interior of the base and their outer faces 50a, 51a outward. The lateral edge extender 51 and two longitudinal edge extenders 50 have their twelfth soft strips 93 and tenth soft strips 89 respectively, mutually oriented downward and engaging the cooperating seventh pointed strip 66, fourth pointed strip 63, and fifth pointed strip 64 respectively forming a U like shape open towards the left in the figure.

With the lateral edge extender 51 and two longitudinal edge extenders 50 installed upon the base, FIG. 45 shows the upper edges 51e, 50e respectively, visible atop their corresponding extenders. The two longitudinal edge extenders 50 connect to the lateral edge extender 51 in a butt joint where the inner ends 50c face towards the left end 51c and the right end 51d and appear concealed in this figure. Because of the butt joint connection, the two longitudinal edge extenders 50 have their outer ends 50d shown and positioned slightly inwards from the lateral edge 13 below, that is, the lateral edge to the left of the FIG. proximate the ramp 90. Inward from this lateral edge shown in the foreground, the base has the ramp 90 installed, generally centered between the longitudinal edges 12 and their corresponding longitudinal edge extenders 50. The lateral edge extender and the longitudinal edge extenders cooperatively form a U shaped opening towards the sixth pointed strip. The lateral edge extender and the longitudinal edge extenders collectively admit a pet into the invention opposite the lateral edge extender.

FIG. 46 then has a top view of the alternate embodiment showing the tops, that is, the upper edges 51e, 50e of the lateral edge extender 51, the longitudinal edge extenders 50 respectively, and the ramp 90. The lateral edge extender 51 and the longitudinal edge extenders 50 have their corresponding upper edges 51e, 50e as without a strip. The ramp shows its tread layer 31 in this view. The ramp has its generally centered position along the lateral edge 13 here shown to the left. As before, the invention forms a compartment within the lateral edge extender 51, the longitudinal edge extenders 50, the longitudinal edges 12, and the lateral edge 13 with the fourth soft strip 83 to the right in this figure.

Having mentioned the ramp previously, FIG. 47 is a front view of the ramp 90 of the alternate embodiment. The ramp has an inclined ramp shape and the layer of tread 31 upon that incline. Beneath and ahead of the incline and the tread in this view, the ramp has a front 90a here shown parallel to the plane of this figure, a left face 90c shown to the left of this figure, a mutually parallel and spaced apart right face 90d to the right of this figure, and an upper edge 90e shown in the background parallel to the front 90a but spaced behind it.

Turning the ramp one hundred eighty degrees, FIG. 48 has a rear view of the ramp 90. The ramp has a back 90b here shown parallel to the plane of the figure and also parallel to the front. The back has a rectangular shape as shown and the upper edge 90e in the foreground. The back joins to the right face 90d, here shown on the left of the figure, and joins mutually parallel and spaced away to the left face 90c on the right of the figure.

FIG. 49 is a side view of the ramp 90, that is, ninety eighty degrees from FIG. 48. The ramp has its right face 90d here shown parallel to the plane of the figure but perpendicular to the front 90a. The right face 90d has a trapezoidal shape, with the front 90a mutually parallel and spaced apart from the back 90 as in two spaced apart bases of a trapezoid and the bottom 90f and an inclined surface 90g beneath the tread 31 spanning between the bases of the trapezoid. With the front having its short height as shown, the ramp appears triangular from a distance when seen from the side. That is, the back is taller than the front. In this view, upper edge 90e appears as the top of the back 90b, here shown on the right of the figure. As before the back 90b and the front 90a have a mutually parallel and spaced apart orientation.

FIG. 50 is another side view of the ramp opposite that of FIG. 49 with the left face 90b parallel to the plane of this figure. Akin to the right face, the left face 90b merges clockwise with the back 90b, the inclined surface 90g, the front 90a, and the bottom 90f as shown. The inclined surface 90g also supports the tread layer 31.

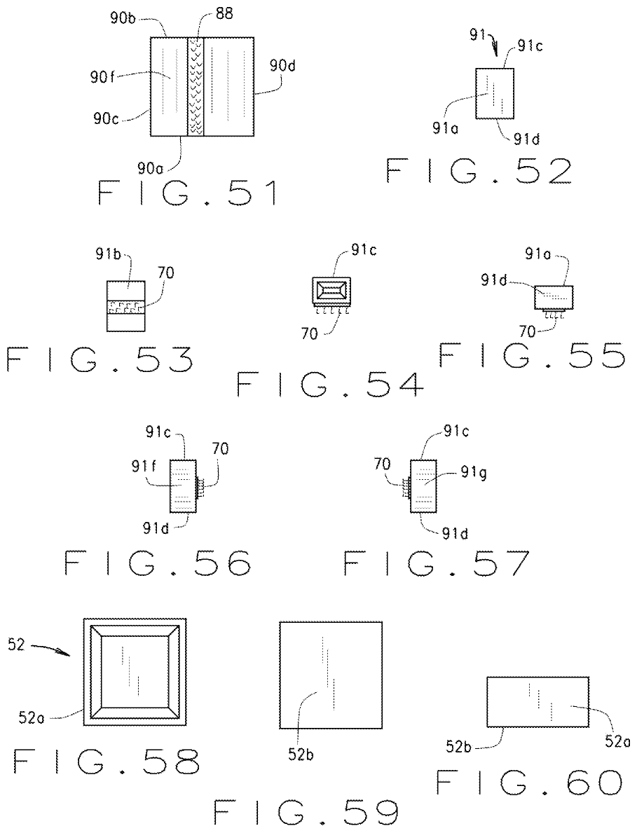

FIG. 51 is a bottom view of the ramp 90 showing the bottom 90f in the foreground. The bottom merges clockwise with the back 90b, the right face 90d, the front 90a, and the left face 90c. The bottom has the ninth soft strip 88 adhered upon it and centered upon it and spanning between the back 90b and the front 90a. The ninth soft strip 88 cooperatively engages the eighth pointed strip 67, see FIGS. 31, 32, when a pet owner places the ramp inside of the lateral edge 13 without the fourth soft strip.

Moving to the next component, FIG. 52 shows a front view of the holder 91 of the alternate embodiment that has a rectangular shape with its front face 91a shown towards the reader. The front face thus has a rectangular shape as shown. Towards the top of the figure, the holder has its upper surface with an opening 91c therein. Towards the bottom of the figure, the holder then has its bottom 91d, here shown on edge. The bottom has a solid form and operates to retain tools and equipment placed into the holder.

FIG. 53 then has a rear view of the holder 91 with the front face 91a into the background and a back face 91b shown towards the reader. The front face and the back face have mutually parallel and spaced apart orientation. The back face has an eleventh pointed strip 70 adhered towards the center of the back face and oriented parallel to the bottom 91d. The eleventh pointed strip 70 cooperatively engages the fourth soft strip 83, see FIGS. 31, 32, upon the lateral edge 13 opposite the ramp 90.

FIG. 54 provides a top view of the holder 91 as seen by a user just before inserting a tool into the holder. The holder has its opening 91c in its upper surface as previously discussed in FIG. 52. The opening extends into the holder to the bottom 91d shown into the plane of the figure. The opening has a generally rectangular shape. In the figure, the back face 91b appears on edge and downward while it shows the eleventh pointed strip 70 on its own side.

Turning the holder over from FIG. 54, FIG. 55 shows a bottom view of the holder 91 with the bottom 91d itself in the foreground. The bottom has a rectangular shape that denotes the width and the depth of the holder. In this view, the holder has the front face 91a shown upward from the bottom 91d and the back face 91b shown downward from the bottom. The back face has the eleventh pointed strip 70 on its narrow end.

FIG. 56 provides a side view of the holder with a right face 91f shown in the foreground and to a user's right when viewing the holder installed upon the fourth soft strip. The right face has a rectangular shape rotated ninety degrees with its longer dimension here shown upright in the figure. The right face spans from the bottom 91d to the opening 91c. To the left of the right face in this figure, the right face merges with the front face 91a. And to the right of the right face in this figure, the right face merges with the back face 91b showing the eleventh pointed strip 70 on its own end. The pointed strip 70 has less width than the longer dimension of the right face, that is, the height of the holder.

FIG. 57 illustrates another side view of the holder opposite FIG. 56. This view of the holder has a left face 91g shown in the foreground and to a user's left when viewing the holder installed upon the fourth soft strip. The left face has the same rectangular shape as the right face, that is, rotated ninety degrees with its longer dimension here shown upright in the figure. The left face spans from the bottom 91d to the opening 91c. To the right of the left face in this figure, it merges with the front face 91a. And to the left of the left face in this figure, the left face merges with the back face 91b that has the eleventh pointed strip 70 on its own end. The pointed strip 70 has less width than the longer dimension of the right face, that is, the height of the holder.

And, FIG. 58 is a top view of the tray 52 of the alternate embodiment of the invention 1. The tray has a square form with four walls 52a joined perpendicular to a bottom 52b upon its four edges as shown, as a rectilinear polygon. The four walls have the same height and the same thickness. The walls have less height than that of a longitudinal edge 12. The four walls have two of them being mutually parallel and spaced apart and the other two of the walls being mutually parallel, spaced apart, and perpendicular to the first pair of walls.

Turning the tray over, FIG. 59 shows a bottom view of the tray 52. The tray in this view has its bottom 52b in the plane of the figure and the walls concealed behind the tray and into the plane of the figure. The bottom 52b has a flat, square shape as shown.

Turning the tray again, FIG. 60 illustrates a side view of the tray 52. As the tray has biaxial symmetry, this view also shows the front, the rear, and the other side of the tray, particularly the walls 52a extending upwardly and perpendicular to the bottom 52b as shown. With the alternate embodiment in the closed configuration and the tray contained inside the base beneath the cover, the tray may hold a portion of kitty litter for use when the alternate embodiment attains the open configuration. In the open configuration, a user or a pet owner, places the invention at a position suitable for a pet. The pet owner then assembles the invention as shown in the previous figures, especially FIGS. 31, 45. The pet, sometimes a cat, approaches the assembled invention and enters the invention over the lateral edge 13 without the fourth soft strip 83 and within a lateral edge extender. The cat then places its paws upon the tread layer 31 on the ramp 90—its inclined surface 91g—and walks into the invention, and into the tray 52. There the cat does its business and then places its paws back on the tread 31 and walks down the ramp 90 and exits the invention.

The Litter Box Containment System for Pets may have wood, plastic, PVC or a composite material. One handle may have a location on either the left or right side, of the invention on a longitudinal edge, in the center for easy carrying or movement of the invention. The pet ramp may have two handles on either side for easy pickup to clean the unit. A tread material, with ribs, covers the top of the pet ramp and a felt material covers the bottom surface of the top cover to prevent scratching a floor or other supporting surface during usage of the invention. The ribs also catch some of the litter carried out of a litter box on a pet's paws. Also, a waterproof material, liner 15, covers the entire interior of the base 10 and its edges 12, 13 and edge extenders 50, 51. In an alternate embodiment, the base, the pet ramp, and the scoop holder could also be manufactured from a single piece of material. In a further alternate embodiment, the base, the longitudinal edges, and the lateral edges are formed from a single piece of material and corners between the base, the longitudinal edges, and the lateral edges extend continuously.

The edges 12, 13 on the base 10 may have any size or height so long as the pet can step over and into the tray to use the invention. The edges have a permanent attachment to the planar plate 17 of the base 10 and have a sufficiently strong connection to the plate to support the weight of an adult person standing on it, approximately 280 lbs. Further, the pet ramp also supports the weight of an adult person. This feature provides a safeguard for when a person does not want to remove the pet ramp when cleaning out the pet box.

The present invention in its preferred and alternate embodiments stands ready to serve pets of all kinds, particularly cats, and their owners in various room types and buildings.

While a preferred embodiment of the Litter Box Containment System for Pets has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. For example, any suitable sturdy material such as plastic, polymer, metal, composite, pine for the planar plate and edging of the base and the lid or another variety of wood may be used instead of the wooden components described. The invention has a construction of a sturdy, lightweight material that resists pet urine stains and resists absorption of such fluids thus making cleaning of pet urine and fluids easy upon the interior and the exterior of the invention. Pet urine resistance becomes a key feature of the invention's construction because if pet urine encounters delay in its cleanup or the pet urine remains within the invention for an extended period of time, the invention suffers no damages and does not retain odors following a later cleaning.

Using the invention, a cat, perhaps named Tiffany or Victoria, will have no problem stepping over the edging of the base unit and into the base then proceeding up the ramp to use the pet box. This invention could also be used by perhaps small dogs, rabbits or any other house pets that are trained to use pet litter and are large enough to step over the edges and proceed up the pet ramp to the pet box.

Although providing a place that contains litter has been described, it should be appreciated that the Litter Box Containment System for Pets herein described is also suitable for apartments, condominiums, dormitory rooms, houses, offices, light industrial facilities, warehouses, garages, motor pools, select mines, and the like where a pet, such as a cat, can find a home.

The Applicant reminds the reader that the invention is not a toy. The edges and edge extenders of the base of the Litter Box Containment System for Pets pose a trip hazard and extreme care must be taken when near the invention or when cleaning a pet box or the unit itself. The present invention may have its edges rounded over or sanded smooth, painting in a variety of colors, and application of additional mechanical fasteners where suitable.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Various aspects of the illustrative embodiments have been described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations have been set forth in order to provide a thorough understanding of the illustrative embodiments. However, it will be apparent to one skilled in the art that the present invention may be practiced without the specific details. In other instances, well known features are omitted or simplified in order not to obscure the illustrative embodiments.

Various operations have been described as multiple discrete operations, in a manner that is most helpful in understanding the present invention, however, the order of description should not be construed as to imply that these operations are necessarily order dependent. In particular, these operations need not be performed in the order of presentation.

Moreover, in the specification and the following claims, the terms “first,” “second,” “third” and the like—when they appear—are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to ascertain the nature of the technical disclosure. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

I claim:

1. A furniture device for containing litter, comprising:
a rectangular, hollow base;
a rectangular, flat cover, said cover releasably connecting upon said base in a closed configuration and said cover releasably connecting below said base in an open configuration;
a ramp releasably connecting within said base;
a holder releasably connecting outward of said base; and
wherein said device is adapted to avoid marring a supporting surface in both the closed configuration and the open configuration.

2. The furniture device of claim 1 further comprising:
said base having a rectangular plate denoting its bottom, two mutually parallel and spaced longitudinal edges joining to said plate, two mutually parallel and spaced apart lateral edges joining to said plate, said lateral edges orienting perpendicular to said longitudinal edges, said lateral edges and said longitudinal edges orienting perpendicular to a plane defined by said plate;
said plate having a first soft strip and a mutually parallel and spaced apart second soft strip, each of first soft strip and said second soft strip adhering beneath each of said lateral edges, and a third soft strip centered between said first soft strip and said second soft strip and spanning between said first soft strip and said second soft strip wherein said first soft strip, said second soft strip, and said third soft strip have the shape of a letter I; and
one of said lateral edges having a fourth soft strip generally above said first soft strip.

3. The furniture device of claim 2 further comprising:
one of said longitudinal edges having a fourth pointed strip generally positioned above said plate;
the other of said longitudinal edges having a fifth pointed strip generally positioned above said plate;
one of said lateral edges having a sixth pointed strip generally positioned above said plate; and
the other of said lateral edges having a seventh pointed strip generally positioned above said plate.

4. The furniture device of claim 3 further comprising:
said cover having a top surface oriented away from said plate in said closed configuration, said top surface having adhered to it a first pointed strip and a mutually parallel and spaced apart second pointed strip, each of said first pointed strip and said second pointed strip adhering above each of said lateral edges in said closed configuration, and a third pointed strip centered between said first pointed strip and said second pointed strip and spanning between said first pointed strip and said second pointed strip wherein said first pointed strip, said second pointed strip, and said third pointed strip have the shape of a letter I;
opposite said top surface, said cover having a fifth soft strip generally in registration with one of said fourth pointed strip upon one of said longitudinal edges and said fifth pointed strip upon the other of said longitudinal edges in said closed configuration, a sixth soft strip generally in registration with the other of said fourth pointed strip upon one of said longitudinal edges and said fifth pointed strip upon the other of said longitudinal edges in said closed configuration, a seventh soft strip generally in registration with one of said sixth pointed strip upon one of said lateral edges and said seventh pointed strip upon the other of said lateral edges in said closed configuration, an eighth soft strip generally in registration with the other of said sixth pointed strip upon one of said lateral edges and said seventh pointed strip upon the other of said lateral edges in said closed configuration;
said fifth soft strip and said sixth soft strip being mutually parallel and spaced apart, said seventh soft strip and said eighth soft strip being mutually parallel and spaced apart and perpendicular to said fifth soft strip and said sixth soft strip; and
a non-marring layer adhered to said cover within said fifth soft strip, said sixth soft strip, said seventh soft strip and said eighth soft strip, and opposite said third pointed strip.

5. The furniture device of claim 4 further comprising:
said cover having said non-marring layer oriented away from said plate in said open configuration, said first pointed strip, said second pointed strip, and said third pointed strip, each of said cover, cooperatively engaging in registration said first soft strip, said second soft strip, and said third soft strip, each of said plate; and
wherein said device is adapted to avoid marring a support surface beneath it.

6. The furniture device of claim 4 further comprising:
said holder having a hollow, elongated prismatic form, a front face and a mutually parallel and spaced apart back face, a bottom perpendicular to said front and to said back face and spaced beneath said front face, a left face and a mutually parallel and spaced apart right face, said left face and said right face being perpendicular to said bottom and to said front face and said back face;
said back face having an eleventh pointed strip generally centered thereon and parallel to said bottom; and
said eleventh pointed strip cooperatively engaging said fourth soft strip upon one of said lateral edges generally above said first soft strip.

7. The furniture device of claim 4 further comprising:
said plate having an eighth pointed strip thereon, said eighth pointed strip generally extending from one of said lateral edges towards said fourth soft strip, said eighth pointed strip being centered between and parallel to said longitudinal edges;
said ramp having a front, a back mutually parallel and spaced apart from said front, said back having a height exceeding that of said front, a left face perpendicular to said front, a right face mutually parallel to and spaced apart from said left face, a bottom beneath and perpendicular to said front, said back, said left face, and said right face, and an inclined face spanning from said front to said back and above said bottom;
a tread layer joining to said incline face wherein said tread is adapted to provide cushioning to a pet using said ramp;
said bottom of said ramp having a ninth soft strip centered thereon and spanning from said front face to said rear face; and
wherein said ramp releasably connects to said plate as said ninth soft strip cooperatively engages said eighth pointed strip.

8. The furniture device of claim 4 further comprising:
two longitudinal edge extenders each having an elongated rectangular shape, an outer face and a mutually parallel and spaced apart inner face, an upper edge and a mutually parallel and spaced apart lower edge, said upper edge and said lower edge being perpendicular to said outer face, an outer end and a mutually parallel and spaced apart inner end, said outer end and said inner end being perpendicular to said upper edge and to said outer face, said upper edge, said lower edge, said outer end, said inner end spanning between said inner face and said outer face;
each longitudinal edge extender having a tenth soft strip adhered to said lower edge and an eleventh soft strip adhered to said inner edge;
one lateral edge extender having an elongated rectangular shape of shorter length than said longitudinal edge extenders, an outer face and a mutually parallel and spaced apart inner face, an upper edge and a mutually parallel and spaced apart lower edge, said upper edge and said lower edge being perpendicular to said outer face, a left end and a mutually parallel and spaced apart right end, said left end and said right end being perpendicular to said upper edge and to said outer face, said upper edge, said lower edge, said left end and said right end spanning between said inner face and said outer face; and
said lateral edge extender having a twelfth soft strip adhered to said lower edge, a ninth pointed strip adhered to said inner face and a tenth pointed strip adhered to said inner face, said ninth pointed strip and said tenth pointed strip being mutually parallel and spaced apart, said ninth pointed strip near said left end and said tenth pointed strip near said right end.

9. The furniture device of claim 8 further comprising:
each of said longitudinal edge extenders releasably connecting to one of said longitudinal edges, more particularly, one of said tenth soft strips of one of said longitudinal edge extenders cooperatively engaging said fourth pointed strip upon one of said longitudinal edges and the other of said tenth soft strips of the other of said longitudinal edge extenders cooperatively engaging said fifth pointed strip upon the other of said longitudinal edges in the open configuration of said device;
wherein each of said longitudinal edge extenders has a coplanar orientation with one of said longitudinal edges and said longitudinal edge extenders have a mutually parallel and spaced apart orientation;
said lateral edge extender releasably connecting to one lateral edge including said twelfth soft strip of said lateral edge extender cooperatively engaging said seventh pointed strip upon one of said lateral edges;
wherein said lateral edge extender has a coplanar orientation with one of said lateral edges proximate said fourth soft strip, and said lateral edge extender being perpendicular to said longitudinal edge extenders;
said lateral edge extender and said longitudinal edge extenders forming a U shaped opening towards said sixth pointed strip; and
wherein said lateral edge extender and said longitudinal edge extenders are adapted to admit a pet into said device opposite said lateral edge extender.

10. The furniture device of claim 4 further comprising:
a water impervious liner upon said plate opposite said first soft strip and said second soft strip, said lateral edges, said longitudinal edges;
wherein said plate, said lateral edges, said longitudinal edges mutually orienting inwardly of said device their water impervious liners;
a tray having a square shape, a bottom, and four walls joining perpendicular to said bottom, two of said walls being mutually parallel and spaced apart and the other two of said walls being mutually parallel, spaced apart, and perpendicular to the first two walls; and
wherein said tray is adapted to receive pet litter.

11. A furniture device for containing litter, comprising:
a rectangular, hollow base, said base having a rectangular plate denoting its bottom, two mutually parallel and spaced longitudinal edges joining to said plate, two mutually parallel and spaced apart lateral edges joining to said plate, said lateral edges orienting perpendicular to said longitudinal edges, said lateral edges and said longitudinal edges orienting perpendicular to a plane defined by said plate;
a rectangular, flat cover, said cover having a top surface and felt opposite said top surface;
wherein said device has a closed configuration with said top surface of said cover opposite said plate and said device is adapted to prevent access within said base;
wherein said device has an open configuration with said felt beneath said plate and said device is adapted to provide access within said base; and
wherein said device is adapted to avoid marring a surface beneath said device in both the closed configuration and the open configuration.

12. The furniture device of claim 11 further comprising:
said plate having strips of releasable fastener adhered thereon opposite said lateral edges and said longitudinal edges, said strips of releasable fastener arranging in the shape of a letter I;
said cover having strips of releasable fastener adhering upon said top surface and arranging in the shape of a letter I and strips of releasable fastener adhering opposite said top surface and arranging as a frame around said felt;
each of said lateral edges having a strip of releasable fastener adhering thereto opposite said plate;
each of said longitudinal edges having a strip of releasable fastener adhering thereto opposite said plate; and
said strips of releasable fastener of said lateral edges and said strips of releasable fastener of said longitudinal edges cooperatively engaging said strips of releasable fastener around said felt, said cover releasably connecting above said device when said device attains said closed configuration.

13. The furniture device of claim 12 further comprising:
said strips of releasable fastener of said lateral edges and said strips of releasable fastener of said longitudinal edges cooperatively engaging said strips of releasable fastener upon said top surface of said cover in registration, said cover releasably connecting below said device in an open configuration.

14. The furniture device of claim 13 further comprising:
two longitudinal edge extenders each having a lower edge and a strip of releasable fastener upon said lower edge, and an inner end perpendicular to said lower edge and a strip of releasable fastener upon said inner end;
one lateral edge extender having a lower edge and a strip of releasable fastener upon said lower edge, and an inner face perpendicular to said lower edge and two spaced apart strips of releasable fastener upon said inner face;
said strips of releasable fastener upon said lower edges of each of said longitudinal edge extenders cooperatively engaging said strips of releasable fastener of said longitudinal edges;
said strip of releasable fastener upon said lower edge of said lateral edge extender cooperatively engaging said strip of releasable fastener of one of said lateral edges;
said strips of releasable fastener upon said inner edges of each of said longitudinal edge extenders cooperatively engaging said strips of releasable fastener of said inner face of said lateral edge extender;
wherein said longitudinal edge extenders and said lateral edge extender form a U like shape upon said longitudinal edges and one of said lateral edges with said device being in said open configuration; and
wherein in said open configuration said device has said cover beneath and adjacent to said plate with said felt opposite said plate.

15. The furniture device of claim 14 further comprising:
a ramp releasably connecting within said base;
said plate having a strip of releasable fastener upon said plate proximate one of said lateral edges and opposite said lateral edge extender of said device when in said open configuration;
said ramp having an inclined surface, a tread layer upon said inclined surface, a bottom beneath said inclined surface, and a strip of releasable fastener upon said bottom surface; and
said strip of releasable fastener upon said plate cooperatively engaging said strip of releasable fastener of said bottom of said ramp.

16. The furniture device of claim 15 further comprising:
a holder releasably connecting outward of said base;
a strip of releasable fastener upon one of said lateral edges beneath said lateral edge extender of said device when in said open configuration, and strip of releasable fastener being outwardly of said base;
said holder having a hollow prismatic shape with an outer face, and a strip of releasable fastener upon said outer face; and
said strip of releasable fastener upon said lateral edge beneath said lateral edge extender cooperatively engaging said strip of releasable fastener of said outer face of said holder.

17. The furniture device of claim 14 further comprising:
said longitudinal edges, said lateral edges, said plate, and said longitudinal edge extenders, each having a water impervious liner mutually facing inwardly, and
said inner face of said lateral edge extender having a water impervious liner.

18. A furniture device for containing litter, comprising:
a rectangular, hollow base, said base having a rectangular plate denoting its bottom, two mutually parallel and spaced longitudinal edges joining to said plate, two mutually parallel and spaced apart lateral edges joining to said plate, said lateral edges orienting perpendicular to said longitudinal edges, said lateral edges and said longitudinal edges orienting perpendicular to a plane defined by said plate;
a rectangular, flat cover, said cover having a top surface and felt opposite said top surface;
wherein said device has a closed configuration with said top surface of said cover opposite said plate and said device is adapted to prevent access within said base;
wherein said device has an open configuration with said felt beneath said plate and said device is adapted to have access within said base;
wherein said device is adapted to avoid marring a surface beneath said device in both the closed configuration and the open configuration;
said plate having strips of releasable fastener adhered thereon opposite said lateral edges and said longitudinal edges, said strips of releasable fastener arranging in the shape of a letter I;
said cover having strips of releasable fastener adhering upon said top surface and arranging in the shape of a letter I and strips of releasable fastener adhering opposite said top surface and arranging as a frame around said felt;
each of said lateral edges having a strip of releasable fastener adhering thereto opposite said plate;
each of said longitudinal edges having a strip of releasable fastener adhering thereto opposite said plate;
said strips of releasable fastener of said lateral edges and said strips of releasable fastener of said longitudinal edges cooperatively engaging said strips of releasable fastener around said felt, said cover releasably connecting above said device wherein said device attains said closed configuration;
said strips of releasable fastener of said lateral edges and said strips of releasable fastener of said longitudinal edges cooperatively engaging said strips of releasable fastener upon said top surface of said cover in registration, said cover releasably connecting below said device wherein said device attains an open configuration;
two longitudinal edge extenders each having a lower edge and a strip of releasable fastener upon said lower edge, and an inner end perpendicular to said lower edge and a strip of releasable fastener upon said inner end;
one lateral edge extender having a lower edge and a strip of releasable fastener upon said lower edge, and an inner face perpendicular to said lower edge and two spaced apart strips of releasable fastener upon said inner face;
said strips of releasable fastener upon said lower edges of each of said longitudinal edge extenders cooperatively engaging said strips of releasable fastener of said longitudinal edges;
said strip of releasable fastener upon said lower edge of said lateral edge extender cooperatively engaging said strip of releasable fastener of one of said lateral edges;
said strips of releasable fastener upon said inner ends of each of said longitudinal edge extenders cooperatively engaging said strips of releasable fastener of said inner face of said lateral edge extender;
wherein said longitudinal edge extenders and said lateral edge extender form a U like shape upon said longitudinal edges and one of said lateral edges with said device being in said open configuration; and
wherein in said open configuration said device has said cover beneath and adjacent to said plate with said felt opposite said plate.

19. The furniture device for containing litter of claim 18, comprising:
a ramp releasably connecting within said base;
said plate having a strip of releasable fastener upon said plate proximate one of said lateral edges and opposite said lateral edge extender of said device when in said open configuration;
said ramp having an inclined surface, a tread layer upon said inclined surface, a bottom beneath said inclined surface, and a strip of releasable fastener upon said bottom surface;
said strip of releasable fastener upon said plate cooperatively engaging said strip of releasable fastener of said bottom of said ramp;
a holder releasably connecting outward of said base;
a strip of releasable fastener upon one of said lateral edges beneath said lateral edge extender of said device when in said open configuration, and strip of releasable fastener being outwardly of said base;
said holder having a hollow elongated prismatic shape with an outer face, and a strip of releasable fastener upon said outer face;
said strip of releasable fastener upon said lateral edge beneath said lateral edge extender cooperatively engaging said strip of releasable fastener of said outer face of said holder;
said longitudinal edges, said lateral edges, said plate, and said longitudinal edge extenders, each having a water impervious liner mutually facing inwardly; and
said inner face of said lateral edge extender having a water impervious liner.
